(19) United States
(12) Patent Application Publication
(10) Pub. No.: US 2005/0275694 A1
(43) Pub. Date: Dec. 15, 2005

(54) Inkjet recording head and inkjet recording apparatus

(76) Inventors: Michiaki Murata, Kanagawa (JP); Hiroyuki Usami, Kanagawa (JP); Yukihisa Koizumi, Kanagawa (JP); Nanao Inoue, Kanagawa (JP)

Correspondence Address: FILDES & OUTLAND. P.C., Suite 2, 20916 Mack Avenue, Grosse Pointe Woods, MI, 48236, US

(21) Appl. No.: 11/081,575

(22) Filed: Mar. 16, 2005

(30) Foreign Application Priority Data
Jun. 11, 2004 (JP) 2004-174080
Jun. 11, 2004 (JP) 2004-174079
Jun. 29, 2004 (JP) 2004-191550
Jan. 24, 2005 (JP) 2005-016099

(51) Int. Cl. B41J 2/045

(52) U.S. Cl. 347/70

(57) ABSTRACT

An inkjet recording head is disclosed. In the inkjet recording head, a pressure chamber, in which ink is filled, communicates with a nozzle which ejects ink droplets. An ink pooling chamber communicates, via an ink flow path, with the pressure chamber. Ink is supplied from the ink pooling chamber through the ink flow path to the pressure chamber. A piezoelectric element, and a driving IC which applies voltage to the piezoelectric element, are provided on a same substrate. A vibrating plate, which structures a portion of the pressure chamber, is displaced by the piezoelectric element. A wire, which is for energizing the driving IC, is formed at a top plate of the ink pooling chamber which is provided at a side of the vibrating plate opposite a side at which the pressure chamber is provided. An inkjet recording apparatus equipped with this inkjet recording head also is disclosed.

### CROSS-REFERENCE TO RELATED APPLICATIONS

This application claims priority under 35 USC 119 from Japanese Patent Applications Nos. 2004-174079, 2004-174080, 2004-191550, and 2005-16099, the disclosures of which are incorporated by reference herein.

### BACKGROUND OF THE INVENTION

1. Field of the Invention

The present invention relates to an inkjet recording head and an inkjet recording apparatus, and more particularly, to an inkjet recording head which has a nozzle which ejects ink droplets, a pressure chamber which communicates with the nozzle and in which ink is filled, a vibrating plate structuring a portion of the pressure chamber, an ink pooling chamber which pools ink to be supplied to the pressure chamber via an ink flow path, and a piezoelectric element which displaces the vibrating plate, and to an inkjet recording apparatus having this inkjet recording head.

2. Description of the Related Art

There have conventionally been known inkjet recording apparatus in which characters, images or the like are printed onto a recording medium such as a recording paper or the like which is conveyed-in along a subscanning direction, by ejecting ink droplets selectively from plural nozzles of an inkjet recording head (hereinafter, simply called “recording head” upon occasion) which moves reciprocatingly in a main scanning direction.

Such an inkjet recording apparatus has piezoelectric system recording heads, thermal system recording heads, or the like. For example, in the case of a piezoelectric system recording head, as shown in FIG. 26, a piezoelectric element (an actuator which converts electrical energy into mechanical energy) 406 is provided at a pressure chamber 404 to which ink is supplied from an ink tank via an ink flow path 402. The piezoelectric element 406 flexurally deforms in a concave form so as to reduce the volume of the pressure chamber 404, thereby applying pressure to the ink within the pressure chamber 404 and ejecting the ink from a nozzle 408 which communicates with the pressure chamber 404 (see, for example, Japanese Patent Application Laid-Open (JP-A) No. 2003-69103).

In recent years, the ability to achieve high resolution printing while keeping the inkjet recording head low-cost and compact has come to be demanded of inkjet recording heads structured in this way. In order to address such demands, the nozzles 408 must be disposed at a high density. However, limits on the number of nozzles arise from the limitations (crosstalk) of the ink flow paths 402 which supply the ink. Further, because the ink flow paths 402 which supply the ink are in the same dimension as the array of the nozzles, the surface area of the recording head is large.

Therefore, as shown in FIG. 27, beneath nozzles 410 (the nozzles 410 are illustrated on top here for convenience of explanation), partitioning walls 412, which are disposed so as to correspond to the peripheral edge portions of the nozzles 410 and which have ink supplying openings 412A, are provided, and ink pools 414, which supply ink to the nozzles 410, are provided around these partitioning walls 412 (see, for example, JP-A No. 2-301445).

The nozzles 410 can be disposed at a high density in this way, but, in this case, limits on the arrangement of piezoelectric elements 418 arise. Namely, in a case in which ink droplets are ejected from the nozzles 410 by the piezoelectric elements 418, it is more efficient to dispose pressure chambers 416 and the piezoelectric elements 418 beneath the nozzles 410. However, in a structure such as that of JP-A No. 2-301445, it is difficult, in terms of the structure thereof, to dispose the pressure chambers 416 and the piezoelectric elements 418 beneath the nozzles 410.

### SUMMARY OF THE INVENTION

Thus, in view of the above-described problems, an object of the present invention is to provide an inkjet recording head which is compact, and in which it is possible to realize a high density of nozzles and high resolution, and which can efficiently eject ink droplets from the nozzles, and to provide an inkjet recording apparatus equipped with this inkjet recording head.

In accordance with a first aspect of the present invention, there is provided an inkjet recording head including: a nozzle ejecting ink droplets; a pressure chamber which communicates with the nozzle and in which ink is filled; a vibrating plate structuring a portion of the pressure chamber; an ink pooling chamber pooling ink to be supplied to the pressure chamber via an ink flow path; a piezoelectric element displacing the vibrating plate; and a driving IC provided on a same substrate as the piezoelectric element, and applying voltage to the piezoelectric element, wherein a first wire for energizing the driving IC is formed at a top plate of the ink pooling chamber which is provided at a side of the vibrating plate opposite a side at which the pressure chamber is provided.

In accordance with a second aspect of the present invention, there is provided an inkjet recording apparatus having an inkjet recording head including: a nozzle ejecting ink droplets; a pressure chamber which communicates with the nozzle and in which ink is filled; a vibrating plate structuring a portion of the pressure chamber; an ink pooling chamber pooling ink to be supplied to the pressure chamber via an ink flow path; a piezoelectric element displacing the vibrating plate; and a driving IC provided on a same substrate as the piezoelectric element, and applying voltage to the piezoelectric element, wherein a first wire for energizing the driving IC is formed at a top plate of the ink pooling chamber which is provided at a side of the vibrating plate opposite a side at which the pressure chamber is provided.

In accordance with a third aspect of the present invention, there is provided an inkjet recording head including: a nozzle ejecting ink droplets; a pressure chamber which communicates with the nozzle and in which ink is filled; a vibrating plate structuring a portion of the pressure chamber; an ink pooling chamber pooling ink to be supplied to the pressure chamber via an ink flow path; a piezoelectric element displacing the vibrating plate; and a driving IC provided on a same substrate as the piezoelectric element, and applying voltage to the piezoelectric element, wherein a first wire for energizing the driving IC is formed at a top plate of the ink pooling chamber which is provided at a side of the vibrating plate opposite a side at which the pressure chamber is provided, and the ink pooling chamber is structured by a piezoelectric element substrate which is formed so as to include the vibrating plate and at which the piezoelectric element is provided, the top plate, and a partitioning wall supporting the top plate, and the first wire and the driving IC are connected at a bump which is disposed between the piezoelectric element substrate and the top plate, and the ink pooling chamber has an ink supplying opening supplying ink, and an air damper absorbing pressure waves of the ink pooled in the ink pooling chamber, and the air damper is provided at the top plate, and the top plate is a resin top plate, and the resin top plate is molded integrally with the air damper and the partitioning wall which structures the ink pooling chamber and supports the resin top plate, and a gap, which is between the vibrating plate and the resin top plate and at which the driving IC is disposed, is filled-in with a resin material.

In accordance with a fourth aspect of the present invention, there is provided an inkjet recording apparatus having an inkjet recording head including: a nozzle ejecting ink droplets; a pressure chamber which communicates with the nozzle and in which ink is filled; a vibrating plate structuring a portion of the pressure chamber; an ink pooling chamber pooling ink to be supplied to the pressure chamber via an ink flow path; a piezoelectric element displacing the vibrating plate; and a driving IC provided on a same substrate as the piezoelectric element, and applying voltage to the piezoelectric element, wherein a first wire for energizing the driving IC is formed at a top plate of the ink pooling chamber which is provided at a side of the vibrating plate opposite a side at which the pressure chamber is provided, and the ink pooling chamber is structured by a piezoelectric element substrate which is formed so as to include the vibrating plate and at which the piezoelectric element is provided, the top plate, and a partitioning wall supporting the top plate, and the first wire and the driving IC are connected at a bump which is disposed between the piezoelectric element substrate and the top plate, and the ink pooling chamber has an ink supplying opening supplying ink, and an air damper absorbing pressure waves of the ink pooled in the ink pooling chamber, and the air damper is provided at the top plate, and the top plate is a resin top plate, and the resin top plate is molded integrally with the air damper and the partitioning wall which structures the ink pooling chamber and supports the resin top plate, and a gap, which is between the vibrating plate and the resin top plate and at which the driving IC is disposed, is filled-in with a resin material.

Other aspects, features and advantages of the present invention will become apparent from the following description taken in conjunction with the accompanying drawings.

### BRIEF DESCRIPTION OF THE DRAWINGS

Preferred embodiments of the present invention will be described in detail based on the following figures, wherein:

FIG. 1 is a schematic perspective view of an inkjet recording apparatus;

FIG. 2 is a schematic perspective view of inkjet recording units installed in a carriage;

FIG. 3 is a schematic plan view showing the structure of an inkjet recording head;

FIG. 4 is a schematic sectional view taken along line X-X of FIG. 3, and showing the structure of the inkjet recording head relating to a first embodiment;

FIG. 5A is a schematic plan view showing a top plate before being cut as the inkjet recording heads;

FIG. 5B is a schematic plan view showing bumps of a driving IC;

FIG. 6 is a schematic perspective view showing a board and the structure of the inkjet recording head;

FIG. 7 is a diagram explaining the overall processes of manufacturing the inkjet recording head relating to the first embodiment;

FIGS. 8A through 8J are diagrams explaining processes of manufacturing a piezoelectric element substrate structuring the inkjet recording head relating to the first embodiment;

FIGS. 9A through 9H are diagrams explaining processes of manufacturing the top plate structuring the inkjet recording head relating to the first embodiment;

FIGS. 10A through 10D are diagrams explaining processes of joining the top plate to the piezoelectric element substrate of the inkjet recording head relating to the first embodiment;

FIG. 11 is a diagram explaining processes of manufacturing a flow path substrate structuring the inkjet recording head relating to the first embodiment;

FIGS. 12A through 12E are diagrams explaining processes of joining the flow path substrate to the piezoelectric element substrate of the inkjet recording head relating to the first embodiment;

FIG. 13 is a diagram explaining an inkjet recording head having a different air damper arrangement;

FIG. 14 is a schematic sectional view taken along line X-X of FIG. 3, and showing the structure of an inkjet recording head relating to a second embodiment;

FIG. 15 is a diagram explaining the overall processes of manufacturing the inkjet recording head relating to the second embodiment;

FIGS. 16A and 16B are diagrams explaining processes of manufacturing a top plate structuring the inkjet recording head relating to the second embodiment;

FIGS. 17A through 17E are diagrams explaining processes of joining the top plate to a piezoelectric element substrate of the inkjet recording head relating to the second embodiment;

FIGS. 18A through 18E are diagrams explaining processes of joining a flow path substrate to the piezoelectric element substrate of the inkjet recording head relating to the second embodiment;

FIGS. 19A and 19B are diagrams explaining an inkjet recording head having a different air damper structure, in the inkjet recording head relating to the second embodiment;

FIG. 20 is a schematic sectional view taken along line X-X of FIG. 3, and showing the structure of an inkjet recording head relating to a third embodiment;

FIGS. 21A and 21B are diagrams explaining processes of manufacturing a piezoelectric element substrate structuring the inkjet recording head relating to the third embodiment;

FIGS. 22A and 22B are diagrams explaining processes of manufacturing a top plate structuring the inkjet recording head relating to the third embodiment;

FIGS. 23A through 23E are diagrams explaining processes of joining the top plate to the piezoelectric element substrate of the inkjet recording head relating to the third embodiment;

FIGS. 24A through 24E are diagrams explaining processes of joining a flow path substrate to the piezoelectric element substrate of the inkjet recording head relating to the third embodiment;

FIGS. 25A and 25B are diagrams explaining an inkjet recording head having a different air damper structure, in the inkjet recording head relating to the third embodiment;

FIG. 26 is a schematic sectional view showing the structure of a conventional inkjet recording head; and

FIG. 27 is an exploded perspective view showing the structure of a conventional inkjet recording head.

### DETAILED DESCRIPTION OF THE INVENTION

Hereinafter, embodiments of the present invention will be described in detail on the basis of the drawings. Explanation will be given in which a recording paper P is used as a recording medium. The conveying direction of the recording paper P in an inkjet recording apparatus 10 is the subscanning direction and is denoted by arrow S, and the direction orthogonal to this conveying direction is the main scanning direction and is denoted by arrow M. Further, in the drawings, when arrow UP and arrow LO are shown, they express the upward direction and the downward direction, respectively, and when up and down are to be expressed, they correspond to these arrows, respectively.

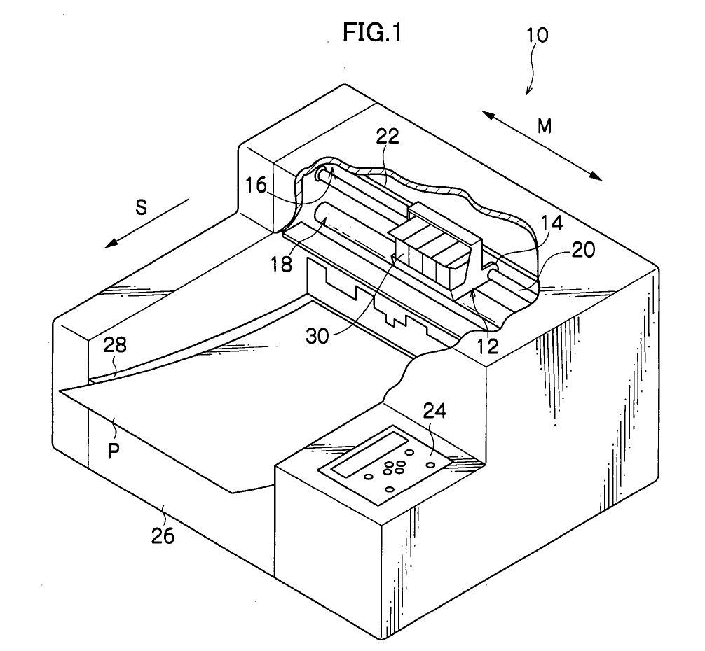

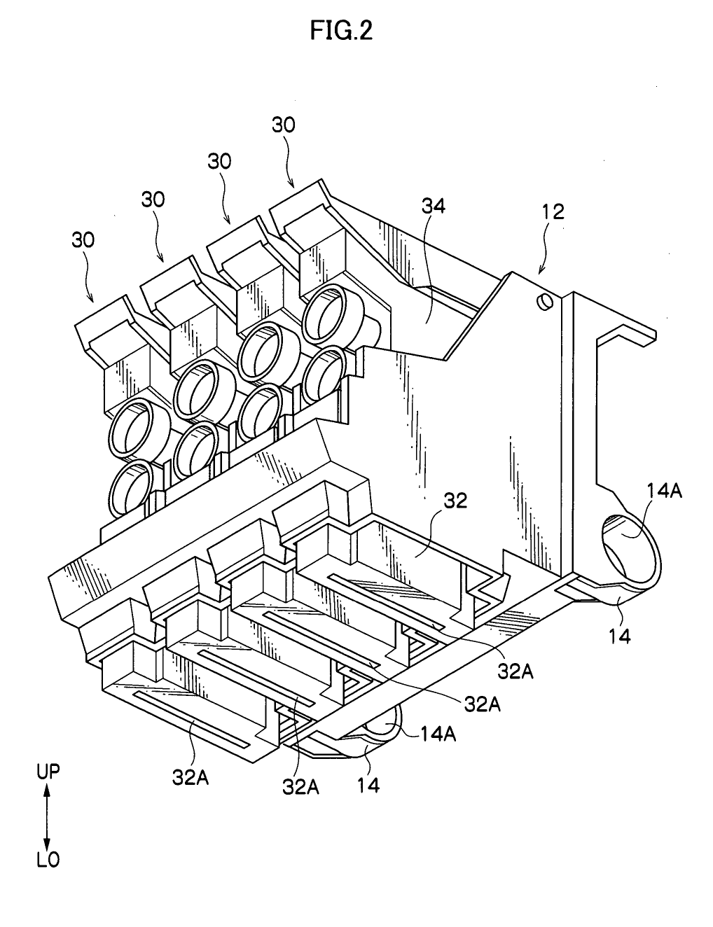

First, a summary of the inkjet recording apparatus 10 will be described. As shown in FIG. 1, the inkjet recording apparatus 10 has a carriage 12 in which are installed inkjet recording units 30 (inkjet recording heads 32) of black, yellow, magenta and cyan. A pair of brackets 14 project from the side of the carriage 12 which is the upstream side in the conveying direction of the recording paper P. Open holes 14A which are round (see FIG. 2) are formed in the brackets 14. A shaft 20, which spans in the main scanning direction, is inserted through the open holes 14A.

A driving pulley (not shown) and a driven pulley (not shown), which structure a main scanning mechanism 16, are disposed at the both ends in the main scanning direction. A portion of a timing belt 22, which is trained around the driving pulley and the driven pulley and which travels in the main scanning direction, is fixed to the carriage 12. Accordingly, the carriage 12 is supported so as to be able to move reciprocatingly in the main scanning direction.

A paper feed tray 26, in which the recording papers P before image printing are placed in a bundle, is provided at the inkjet recording apparatus 10. A catch tray 28 is provided above the paper feed tray 26. The recording papers P, on which images have been printed by the inkjet recording heads 32, are discharged out onto the catch tray 28. Also provided is a subscanning mechanism 18 formed from a discharging roller and a conveying roller which conveys the recording papers P, which are fed-out one-by-one from the paper feed tray 26, at a predetermined pitch in the subscanning direction.

In addition, a control panel 24 for carrying out various types of settings at the time of printing, a maintenance station (not shown), and the like are provided at the inkjet recording apparatus 10. The maintenance station is structured so as to include a capping member, a suction pump, a dummy jet receptacle, a cleaning mechanism, and the like, and carries out maintenance operations such as suctioning and recovering, dummy jetting, cleaning, and the like.

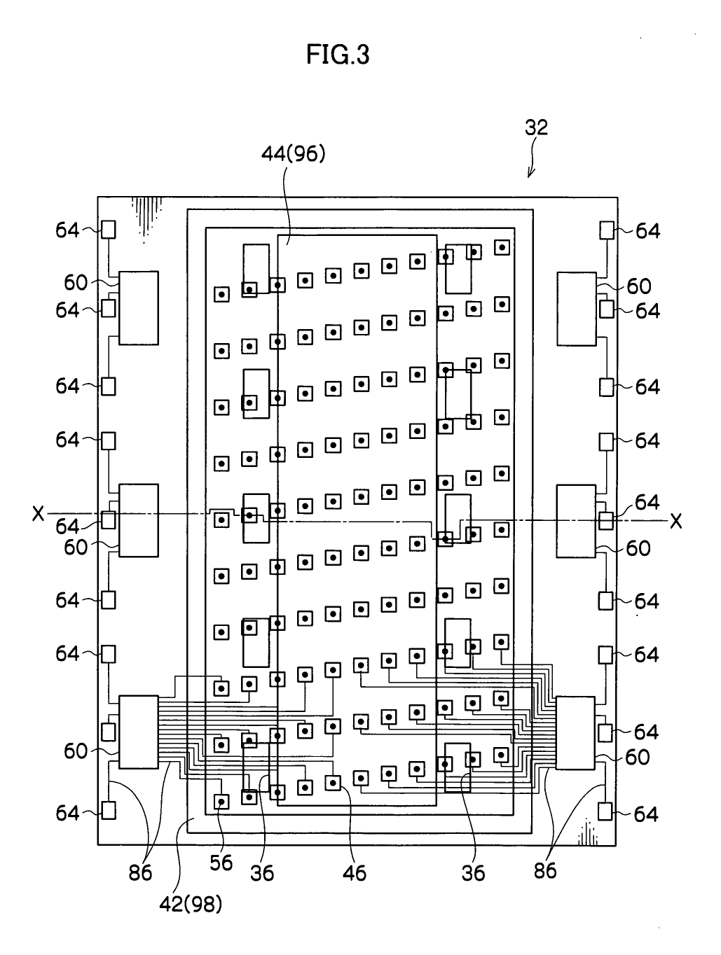

As shown in FIG. 2, at the inkjet recording unit 30 of each color, the inkjet recording head 32 and an ink tank 34, which supplies ink to the inkjet recording head 32, are structured integrally. The inkjet recording unit 30 is installed in the carriage 12 such that plural nozzles 56 (see FIG. 3), which are formed in an ink ejecting surface 32A at the center of the bottom surface of the inkjet recording head 32, face the recording paper P. Accordingly, due to the inkjet recording heads 32 selectively ejecting ink droplets from the nozzles 56 onto the recording paper P while the inkjet recording heads 32 are moved in the main scanning direction by the main scanning mechanism 16, a portion of an image based on image data is recorded at a predetermined band region.

When movement of one time in the main scanning direction is completed, the recording paper P is conveyed by a predetermined pitch in the subscanning direction by the subscanning mechanism 18. A portion of the image based on the image data is recorded on the next band region while the inkjet recording heads 32 (the inkjet recording units 30) are again moved in the main scanning direction (in the direction opposite to that previously). By repeating this operation plural times, the entire image which is based on the image data is recorded on the recording paper P in full color.

Next, the inkjet recording head 32 in the inkjet recording apparatus 10 having the above-described structure will be described in detail.

### First Embodiment

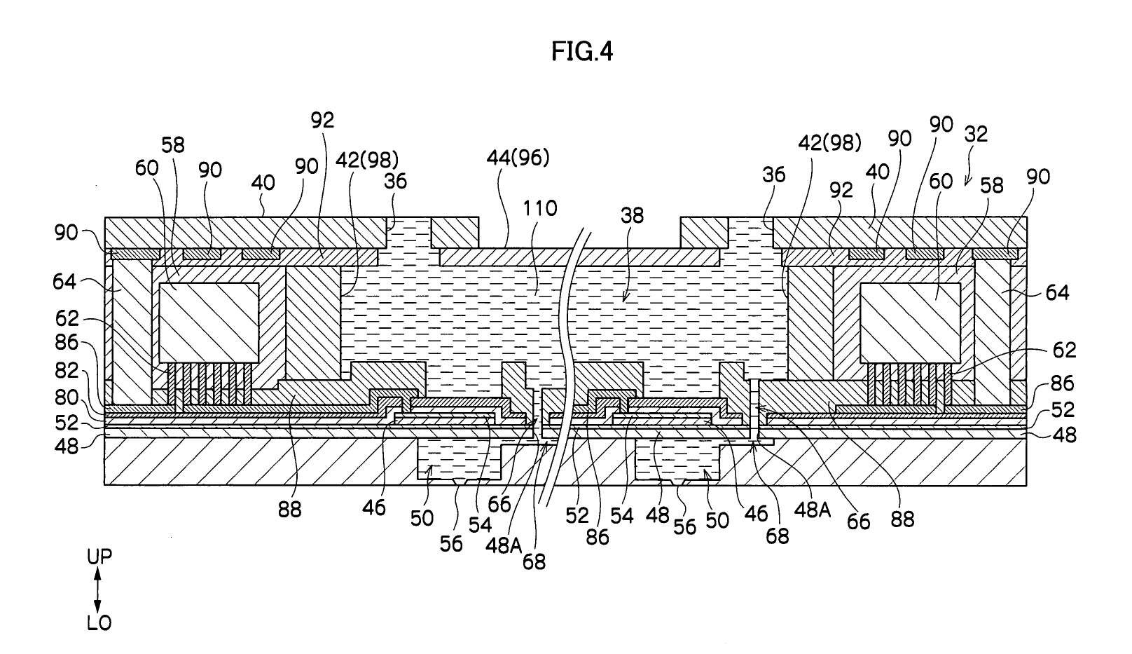

FIG. 3 is a schematic plan view showing the structure of the inkjet recording head 32, and FIG. 4 is a schematic sectional view taken along line X-X of FIG. 3. As shown in FIGS. 3 and 4, ink supplying ports 36, which communicate with the ink tank 34, are provided at the inkjet recording head 32. Ink 110, which is injected-in from these ink supplying ports 36, is pooled in an ink pooling chamber 38.

The volume of the ink pooling chamber 38 is regulated by a top plate 40 and a partitioning wall 42. A plurality of the ink supplying ports 36 are formed in lines at predetermined places of the top plate 40. Further, an air damper 44 (a photosensitive dry film 96 which will be described later), which is made of resin and mitigates pressure waves, is provided in the ink pooling chamber 38, further toward the inner side than the top plate 40 and between the ink supplying ports 36 which form the lines.

Any material, such as glass, ceramic, silicon, resin, or the like for example, may be used as the material of the top plate 40, provided that it is an insulator which has a strength such that it can become the supporting body of the inkjet recording head 32. Further, metal wires 90, which are for energizing driving ICs 60 which will be described later, are provided at the top plate 40. The metal wires 90 are covered and protected by a resin film 92, such that erosion of the metal wires 90 due to the ink 110 is prevented.

The partitioning wall 42 is molded of resin (a photosensitive dry film 98 which will be described later), and partitions the ink pooling chamber 38 into a rectangular shape. Further, the ink pooling chamber 38 is separated, above and below, into piezoelectric elements 46 and pressure chambers 50, via a vibrating plate 48 which is flexurally deformed in the top-bottom direction by the piezoelectric elements 46. Namely, the piezoelectric elements 46 and the vibrating plate 48 are structured so as to be disposed between the ink pooling chamber 38 and the pressure chambers 50, and the ink pooling chamber 38 and the pressure chambers 50 are structured so as to not exist on the same horizontal plane.

Accordingly, the pressure chambers 50 can be disposed in states of being near to one another, and the nozzles 56 can be disposed in the form of a matrix and at a high density. Due to such a structure, an image can be formed in a wide band region due to the carriage 12 moving one time in the main scanning direction. Therefore, the scanning time can be made to be short. Namely, it is possible to realize high-speed printing in which an image is formed over the entire surface of the recording paper P in a short time and by a small number of times of movement of the carriage 12.

The piezoelectric element 46 is adhered onto the top surface of the vibrating plate 48 for each pressure chamber 50. The vibrating plate 48 is molded of a metal such as SUS or the like, and is elastic at least in the top-bottom direction. When the piezoelectric element 46 is energized (i.e., when voltage is applied to the piezoelectric element 46), the vibrating plate 48 flexurally deforms (is displaced) in the top-bottom direction. Note that the vibrating plate 48 may be an insulating material such as glass or the like. A lower electrode 52, which is one polarity, is disposed at the bottom surfaces of the piezoelectric elements 46. Upper electrodes 54, which are the other polarity, are disposed on the top surfaces of the piezoelectric elements 46. The driving ICs 60 are electrically connected to the upper electrodes 54 by metal wires 86.

The piezoelectric elements 46 are covered and protected by a low water permeable insulating film (an SiOx film) 80. The low water permeable insulating film 80 (SiOx film), which covers and protects the piezoelectric elements 46, is formed under the condition that the moisture permeability is low. Therefore, the low water permeable insulating film 80 can prevent poor reliability due to moisture penetrating into the piezoelectric elements 46 (a deterioration in the piezoelectric characteristic caused by the oxygen within the PZT film reducing). Note that the vibrating plate 48, which is formed of metal (SUS or the like) and contacts the lower electrode 52, also functions as a low-resistance GND wire.

Moreover, at the piezoelectric elements 46, the top surface of the low water permeable insulating film (SiOx film) 80 is covered and protected by a resin film 82. In this way, the resistance to erosion by the ink 110 is ensured at the piezoelectric elements 46. The metal wires 86 as well are covered and protected by a resin protective film 88, such that erosion of the metal wires 86 due to the ink 110 is prevented.

The regions above the piezoelectric elements 46 are covered and protected by the resin film 82, and are not covered by the resin protective film 88. Because the resin film 82 is a flexible resin layer, due to such a structure, impeding of displacement of the piezoelectric elements 46 (the vibrating plate 48) is prevented (the piezoelectric elements 46 (the vibrating plate 48) can flexurally deform appropriately in the top-bottom direction). Namely, at the resin layer above the piezoelectric element 46, the thinner the layer, the better the effect of suppressing the impeding of displacement. Therefore, the resin protective film 88 is not covered above the piezoelectric elements 46.

The driving ICs 60 are disposed at the outer sides of the ink pooling chamber 38 which is prescribed by the partitioning wall 42, and between the top plate 40 and the vibrating plate 48. The driving ICs 60 are structured so as to not be exposed (not project out) from the vibrating plate 48 or the top plate 40. Accordingly, the inkjet recording head 32 can be made more compact.

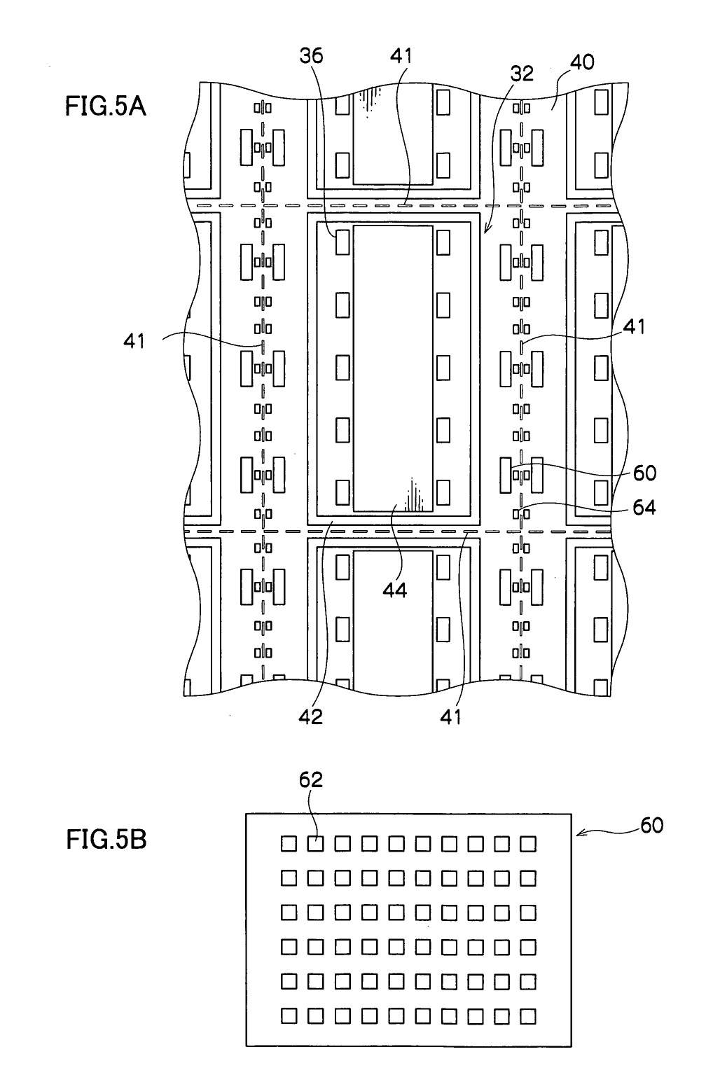

The peripheries of the driving ICs 60 are sealed by a resin material 58. As shown in FIG. 5A, plural injection openings 41 for the resin material 58 which seals the driving ICs 60 are formed in the top plate 40 in the manufacturing step, in a grid-like form so as to partition the respective inkjet recording heads 32. After the uniting (joining) of a piezoelectric element substrate 70 and a flow path substrate 72 which will be described later, the top plate 40 is cut along the injection openings 41 which are sealed (closed) by the resin material 58. In this way, a plurality of the inkjet recording heads 32, which have the nozzles 56 (see FIG. 3) in a matrix form, are manufactured at one time.

As shown in FIGS. 4 and 5B, plural bumps 62 project out by predetermined heights and in the form of a matrix at the bottom surface of the driving IC 60, so as to be flip-chip assembled at the metal wires 86 of the piezoelectric element substrate 70 at which the piezoelectric elements 46 are formed on the vibrating plate 48. Accordingly, high-density connection to the piezoelectric elements 46 can be realized easily, and a reduction in the height of the driving IC 60 is possible (the driving IC 60 can be made thinner). For this reason as well, the inkjet recording head 32 can be made more compact.

Bumps 64 are provided at the outer sides of the driving ICs 60 in FIG. 3. The bumps 64 connect metal wires 90 provided at the top plate 40, and the metal wires 86 provided at the piezoelectric element substrate 70. The bumps 64 are of course provided so as to be higher than the heights of the driving ICs 60 assembled on the piezoelectric element substrate 70.

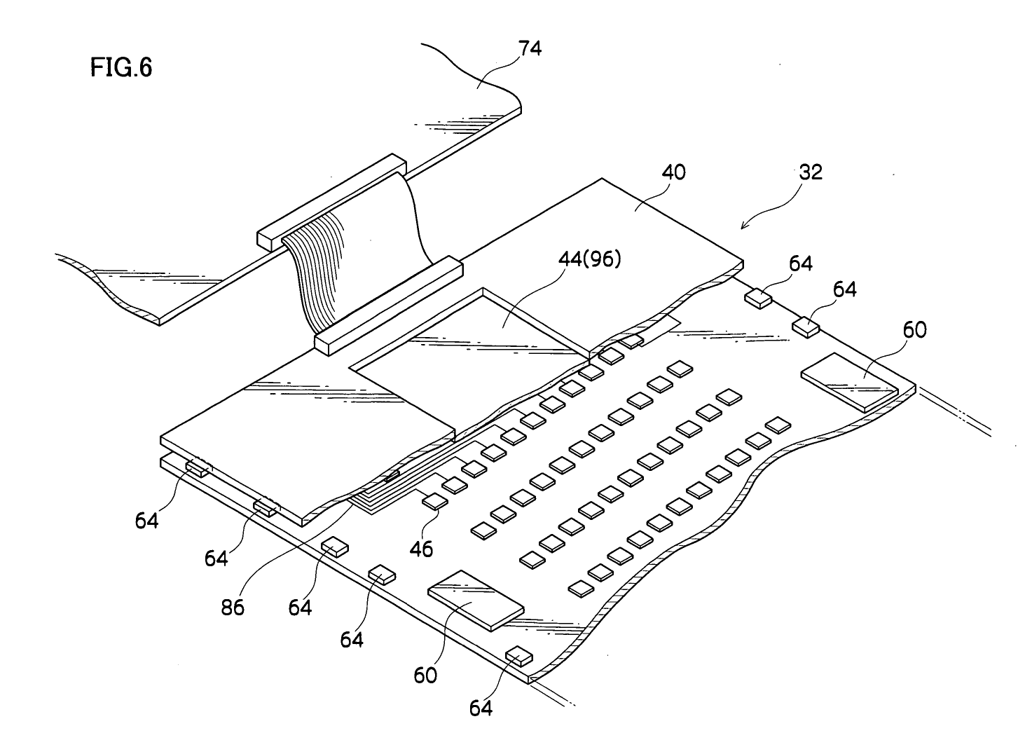

Accordingly, as shown in FIGS. 4 and 6, the metal wires 90 of the top plate 40 are energized from a board 74, which is provided at the main body of the inkjet recording apparatus 10 and which controls the ejecting of the ink, and the metal wires 86 are energized from the metal wires 90 of the top plate 40 via the bumps 64, and the driving ICs 60 are energized therefrom. Voltage is applied to the piezoelectric elements 46 at predetermined times by the driving ICs 60, such that the vibrating plate 48 is flexurally deformed in the top-bottom direction. The ink 110 filled in the pressure chambers 50 is thereby pressurized, such that ink droplets are ejected from the nozzles 56.

One nozzle 56 which ejects the ink droplets is provided for each pressure chamber 50, at a predetermined position thereof. The pressure chamber 50 and the ink pooling chamber 38 are connected by an ink flow path 66 and an ink flow path 68 communicating with one another. The ink flow path 66 bypasses the piezoelectric element 46 and passes through a through-hole 48A formed in the vibrating plate 48. The ink flow path 68 extends horizontally in FIG. 4 from the pressure chamber 50. The ink flow path 68 is provided in advance so as to be a little longer than the portion actually connected to the ink flow path 66, such that the ink flow path 68 can be aligned with the ink flow path 66 (such that they can reliably be made to communicate with one another) at the time of manufacturing the inkjet recording head 32.

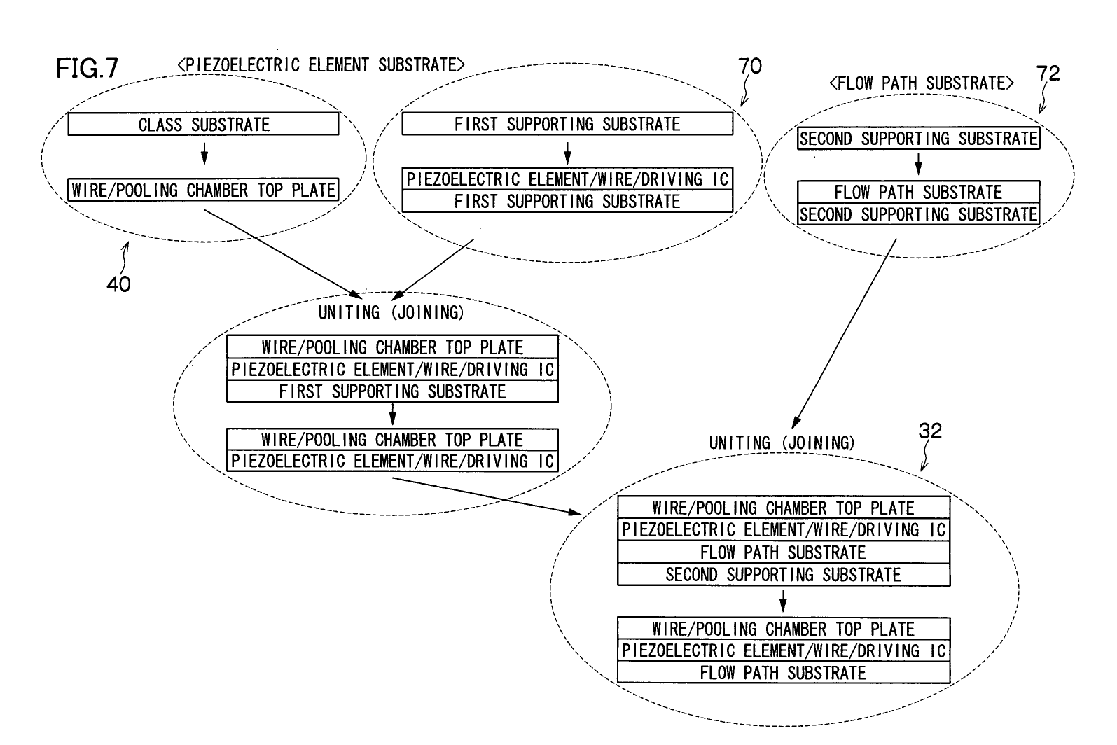

Next, the manufacturing processes of the inkjet recording head 32, which is structured as described above, will be described in detail on the basis of FIG. 7 through 13. As shown in FIG. 7, the inkjet recording head 32 is manufactured by forming the piezoelectric element substrate 70 and the flow path substrate 72 separately, and uniting (joining) the two together. Thus, the process of manufacturing the piezoelectric element substrate 70 will be described first. However, the top plate 40 is united (joined) to the piezoelectric element substrate 70 before the flow path substrate 72.

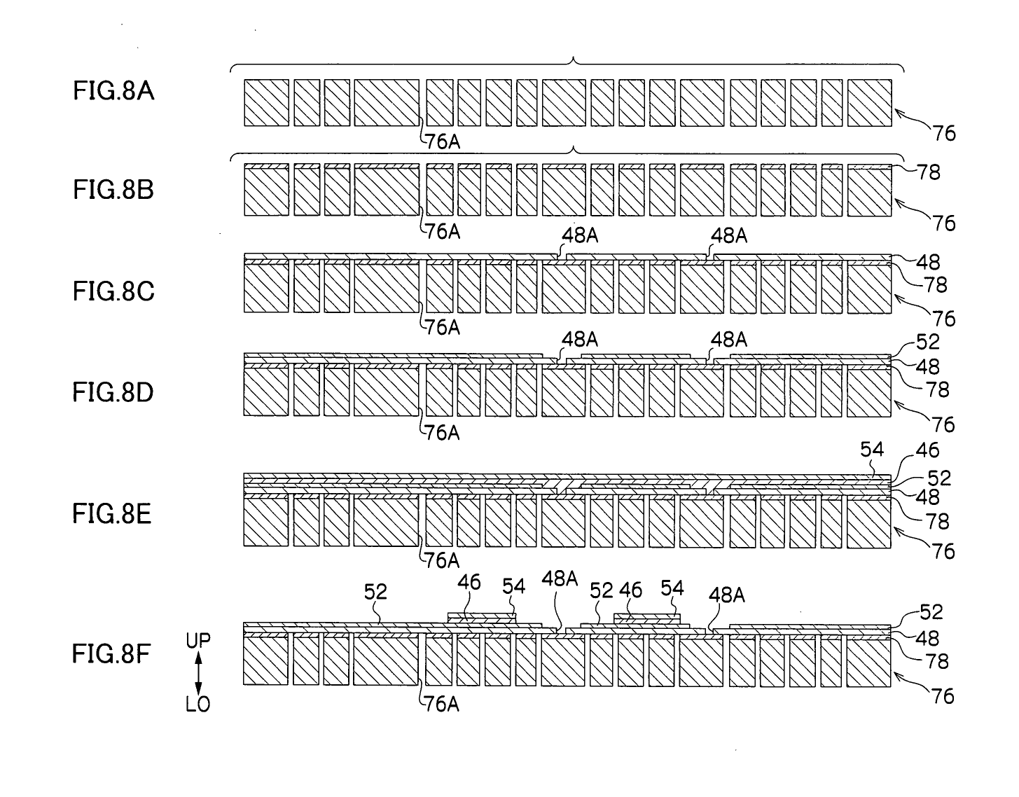

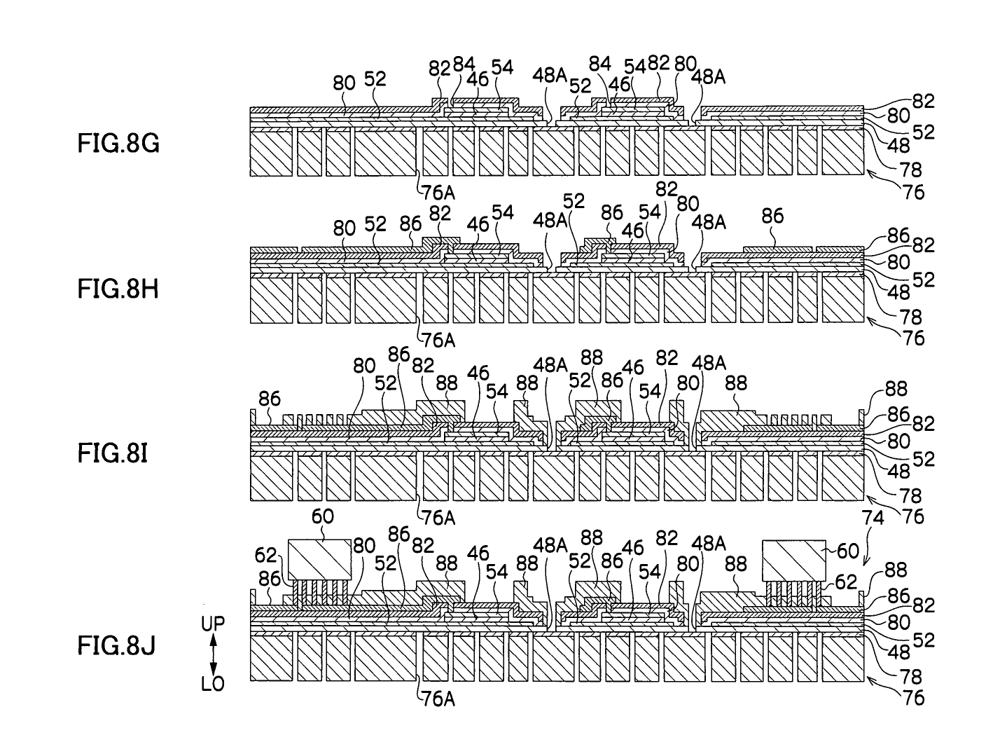

As shown in FIG. 8A, first, a first supporting substrate 76, which is formed of glass and in which plural through-holes 76A are formed, is readied. The first supporting substrate 76 may be any material provided that it does not flex, and is not limited to being formed of glass, but glass is preferable as it is hard and inexpensive. Femtosecond laser machining of a glass substrate, exposure and development of a photosensitive glass substrate (e.g., PEG3C manufactured by Hoya Corporation), and the like are known as methods for fabricating the first supporting substrate 76.

Then, as shown in FIG. 8B, an adhesive 78 is applied to the top surface (the obverse) of the first supporting substrate 76, and, as shown in FIG. 8C, the vibrating plate 48 which is formed of metal (SUS or the like) is adhered on the top surface. At this time, the through-holes 48A of the vibrating plate 48 and the through-holes 76A of the first supporting substrate 76 are not superposed (do not overlap). Note that an insulating substrate of glass or the like may be used as the material of the vibrating plate 48.

Here, the through-holes 48A of the vibrating plate 48 are for forming the ink flow paths 66. Further, the reasons why the through-holes 76A are provided in the first supporting substrate 76 are in order to allow a chemical liquid (solvent) to flow-in to the boundary surface between the first supporting substrate 76 and the vibrating plate 48 in a later step, and in order to dissolve the adhesive 78 and remove the first supporting substrate 76 from the vibrating plate 48. Further, the reason why the through-holes 76A of the first supporting substrate 76 and the through-holes 48A of the vibrating plate 48 are made to not overlap is in order for the respective materials which are used in manufacturing to not leak out from the bottom surface (the reverse surface) of the first supporting substrate 76.

Next, as shown in FIG. 8D, the lower electrode 52, which is layered on the top surface of the vibrating plate 48, is patterned. Concretely, metal film sputtering (film thickness: 500 Å to 3000 Å), resist formation by photolithography, patterning (etching), and resist removal by oxygen plasma are carried out. This lower electrode 42 is a ground potential. Next, as shown in FIG. 8E, a PZT film, which is the material of the piezoelectric elements 46, and the upper electrodes 54 are layered in that order by sputtering on the top surface of the lower electrode 52. As shown in FIG. 8F, the piezoelectric elements 46 (the PZT film) and the upper electrodes 54 are patterned.

Specifically, PZT film sputtering (film thickness: 3 μm to 15 μm), metal film sputtering (film thickness: 500 Å to 3000 Å), resist formation by photolithography, patterning (etching), and resist removal by oxygen plasma are carried out. Examples of the material for the lower and upper electrodes include Au, Ir, Ru, Pt, and the like, which are heat-resistant and have good affinity with the PZT material which is the piezoelectric elements.

Thereafter, as shown in FIG. 8G, the low water permeable insulating film (SiOx film) 80 is layered on the top surfaces of the lower electrode 52 and the upper electrodes 54 which are exposed at the top surface. Then, the resin film 82 which is ink-resistant and flexible, e.g., a resin film of a polyimide, a polyamide, an epoxy, a polyurethane, a silicon, or the like, is layered on the top surface of the low water permeable insulating film (SiOx film) 80. By patterning these, openings 84 (contact holes) for connecting the piezoelectric elements 46 and the metal wires 86 are formed.

Specifically, the following processes are carried out: the low water permeable insulating film (SiOx film) 80 which has a high dangling bond density is formed by Chemical Vapor Deposition (CVD), a photosensitive polyimide (e.g., photosensitive polyimide Durimide 7520 manufactured by FUJIFILM Electronics Materials Co., Ltd.) is coated, exposed, and developed so as to be patterned, and the SiOx film is etched by using the photosensitive polyimide as a mask, by Reactive Ion Etching (RIE) using CF₄ gas. Note that an SiOx film is used as the low water permeable insulating film here, but an SiNx film, an SiOxNy film, or the like may be used.

Next, as shown in FIG. 8H, a metal film is layered on the top surfaces of the resin film 82 and the upper electrodes 54 within the openings 84, and the metal wires 86 are patterned. Concretely, the following processes are carried out: an Al film (thickness: 1 μm) is formed by sputtering, a resist is formed by photolithography, the Al film is etched by RIE using a chlorine gas, and the resist film is removed by oxygen plasma. The upper electrodes 54 and the metal wires 86 (the Al film) are joined. Note that, although not illustrated, the openings 84 are provided above the lower electrode 52 as well, and the metal wires 86 are connected in the same way as with the upper electrodes 52.

Then, as shown in FIG. 8I, the resin protective film 88 (e.g., photosensitive polyimide Durimide 7320 manufactured by FUJIFILM Electronics Materials Co., Ltd.) is layered on the top surfaces of the metal wires 86 and the resin film 82, and is patterned. This resin protective film 88 is formed of the same type of resin material as the resin film 82. At this time, the resin protective film 88 is not layered on the regions above the piezoelectric elements 46 where the metal wires 86 are not patterned (only the resin film 82 is layered thereat).

The reason why the resin protective film 88 is not layered above the piezoelectric elements 46 (on the top surface of the resin film 82) is in order to prevent the displacement (flexural deformation in the top-bottom direction) of the vibrating plate 48 (the piezoelectric elements 46) from being impeded. Further, when the metal wires 86, which are led out from the upper electrodes 54 of the piezoelectric elements 46 (connected to the upper electrodes 54), are covered by the resin protective film 88, because the resin protective film 88 is formed of the same type of resin material as the resin film 82 on which the metal wires 86 are layered, the joining forces thereof which cover the metal wires 86 are strong, and corrosion of the metal wires 86 due to the ink 10 penetrating-in from the boundary surface can be prevented.

Because the resin protective film 88 is formed of the same type of resin material as the partitioning wall 42 (the photosensitive dry film 98) as well, the joining force with respect to the partitioning wall 42 (the photosensitive dry film 98) also is strong. Accordingly, the penetrating-in of ink 110 from the boundary surfaces is prevented even more. Further, using the same type of resin material in this way is advantageous in that, because the coefficients of thermal expansion thereof are substantially equivalent, there is little generation of thermal stress.

Next, as shown in FIG. 8J, the driving ICs 60 are flip-chip assembled on the metal wires 86 via the bumps 62. At this time, the driving ICs 60 are worked to a predetermined thickness (70 μm to 300 μm) in a grinding process carried out in advance at the end of the semiconductor wafer processes. If the driving ICs 60 are too thick, patterning of the partitioning wall 42 and formation of the bumps 64 are difficult.

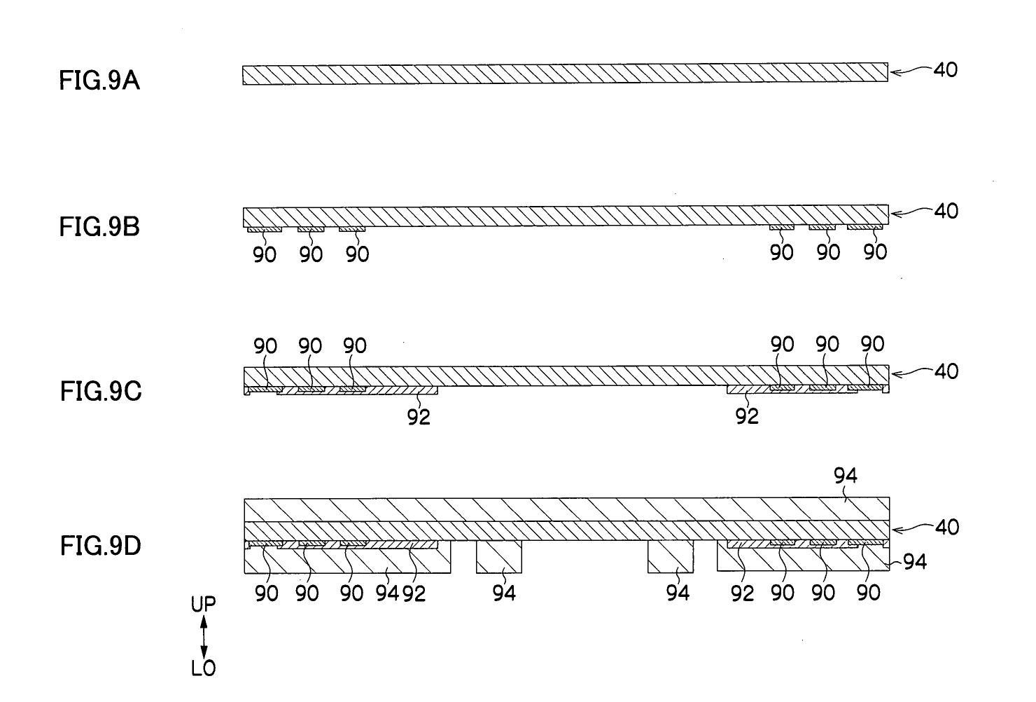

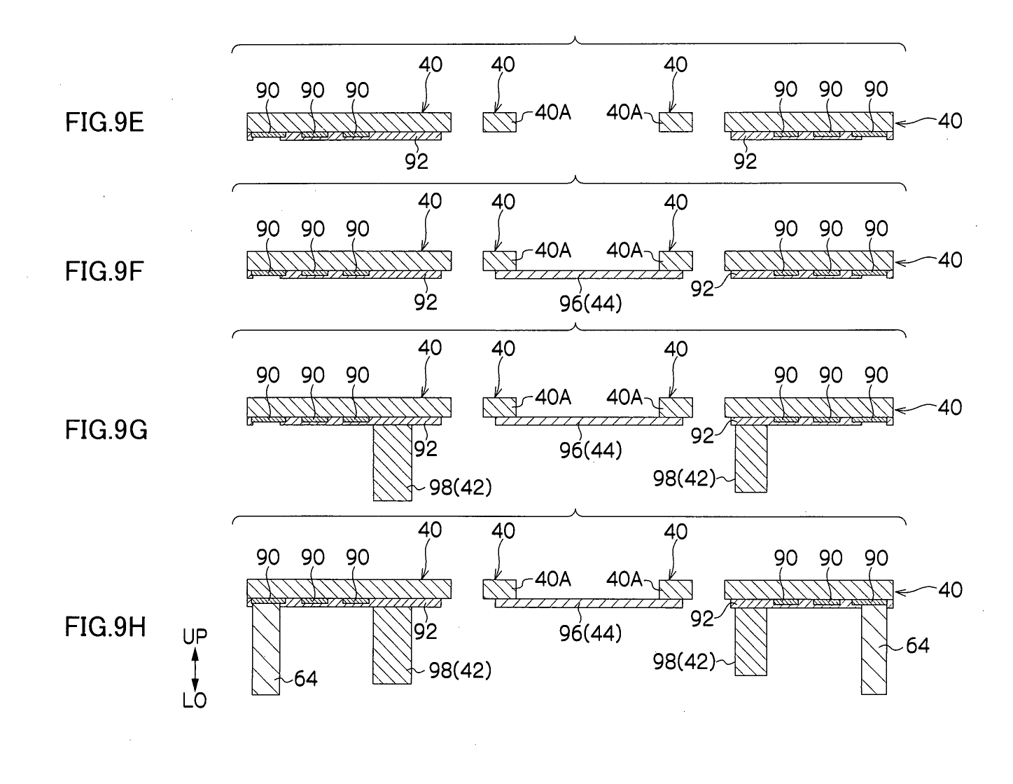

Electroplating, electroless plating, a ball bump process, screen printing, or the like can be used as the method for forming the bumps 62 for flip-chip assembling the driving ICs 60 on the metal wires 86. In this way, the piezoelectric element substrate 70 is fabricated, and the top plate 40, which is made of glass for example, is united (joined) thereto. Note that, for convenience of explanation, in FIGS. 9A through 9H to be described hereinafter, description is given with the wire formation surface being the bottom surface, but the wire formation surface is the top surface in the actual processes.

In manufacturing the glass top plate 40, as shown in FIG. 9A, the top plate 40 itself has a thickness (0.3 mm to 1.5 mm) which can ensure strength of an extent needed for the top plate 40 to be a supporting body. Therefore, there is no need to provide a separate supporting body. First, as shown in FIG. 9B, the metal wires 90 are layered on the bottom surface of the top plate 40, and patterning is carried out. Concretely, the following processes are carried out: an Al film (thickness: 1 μm) is formed by a sputtering method, a resist is formed by photolithography, the Al film is etched by RIE (reactive ion etching process) using a chlorine gas, and the resist film is removed by oxygen plasma.

Then, as shown in FIG. 9C, the resin film 92 (e.g., photosensitive polyimide Durimide 7320 manufactured by FUJIFILM Electronics Materials Co., Ltd.) is layered on the surface at which the metal wires 90 are formed, and patterning is carried out. Note that, at this time, the resin film 92 is not layered on some of the metal wires 90 in order to join the bumps 64.

Next, as shown in FIG. 9D, a resist is patterned by photolithography on the surface of the top plate 40 where the metal wires 90 are formed. The surface where the metal wires 90 are not formed is entirely covered by a resist 94 for protection. Here, the resist 94 for protection is coated in order to prevent the top plate 40 from being etched from the reverse surface of the surface where the metal wires 90 are formed, in the subsequent wet (SiO₂) etching step. Note that, in a case in which a photosensitive glass is used as the top plate 40, this step of applying the resist 94 for protection can be omitted.

Next, as shown in FIG. 9E, wet (SiO₂) etching by an HF solution is carried out on the top plate 40, and thereafter, the resist 94 for protection is removed by oxygen plasma. Then, as shown in FIG. 9F, at the portion of the opening 40A formed in the top plate 40, the photosensitive dry film 96 (e.g., Raytec FR-5025 manufactured by Hitachi Chemical Co., Ltd., thickness: 25 μm) is patterned (bridged) by exposure and development. This photosensitive dry film 96 becomes the air damper 44 which mitigates pressure waves.

Subsequently, as shown in FIG. 9G, the photosensitive dry film 98 (thickness: 100 μm) is layered on the resin film 92, and is patterned by exposure and development. This photosensitive dry film 98 becomes the partitioning wall 42 which prescribes the ink pooling chamber 38. Note that the partitioning wall 42 is not limited to the photosensitive dry film 98, and may be a resin coated film (e.g., SU-8 resist manufactured by Kayaku Microchem Corporation). At this time, it suffices for coating to be carried out by a spray coating device, and for exposure and development to be carried out.

Finally, as shown in FIG. 9H, the bumps 64 are formed by plating or the like on the metal wires 90 on which the resin film 92 is not layered. In order to electrically connect these bumps 64 to the metal wires 86 of the driving ICs 60, as illustrated, the heights of the bumps 64 are formed to be higher than that of the photosensitive dry film 98 (the partitioning wall 42).

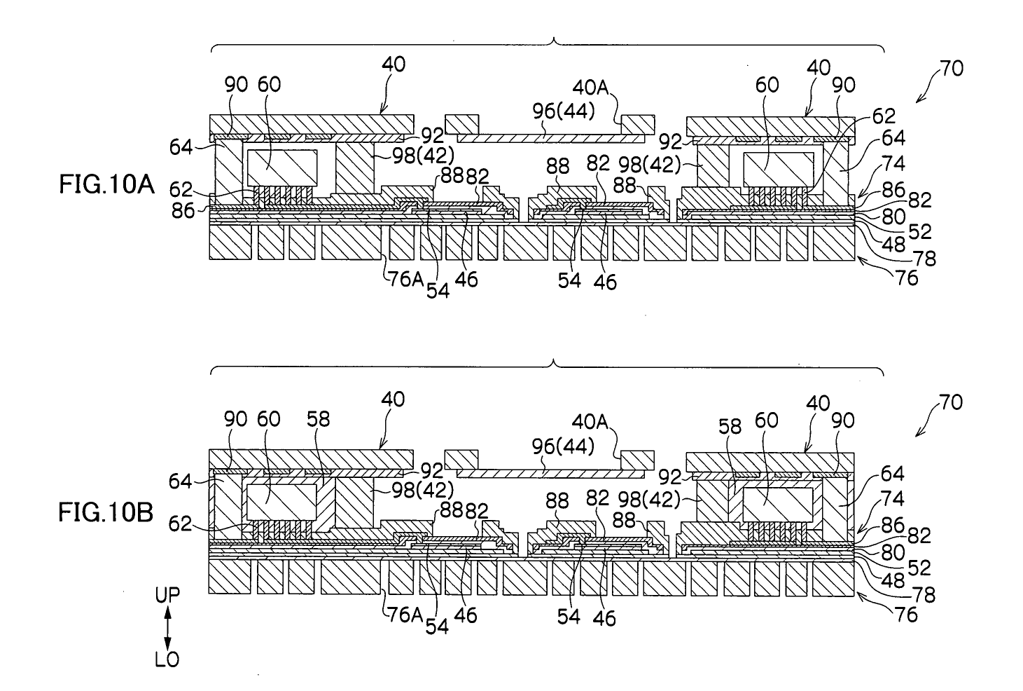

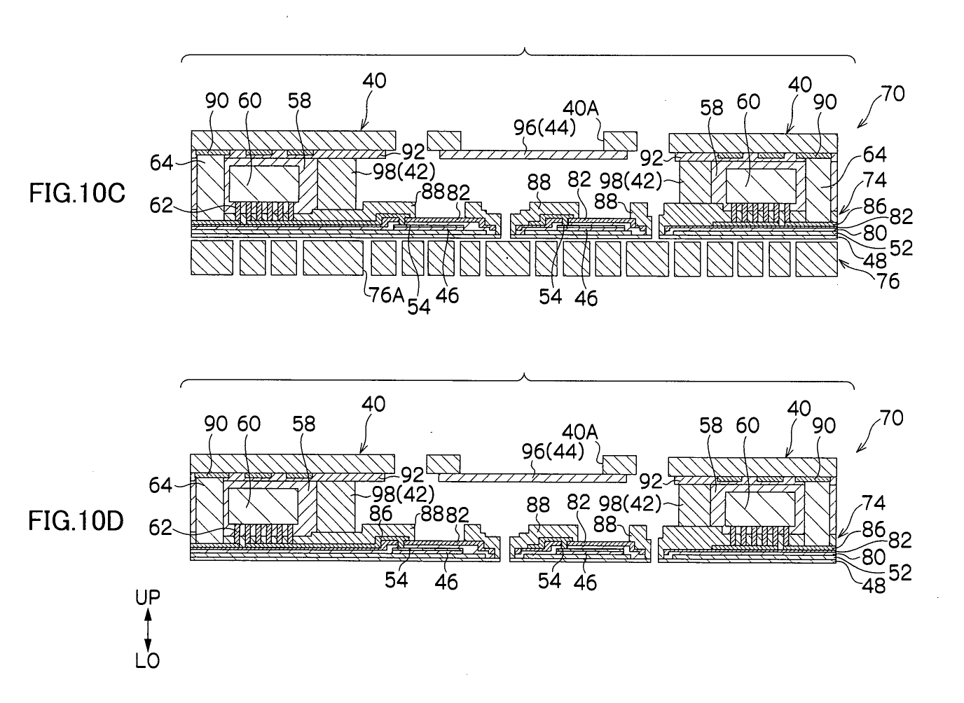

After the top plate 40 is manufactured in this way, as shown in FIG. 10A, the top plate 40 is placed on the piezoelectric element substrate 70, and the both are united (joined) together by thermocompression bonding. Namely, the photosensitive dry film 98 (the partitioning wall 42) is joined to the resin protective film 88 which is a photosensitive resin layer, and the bumps 64 are joined to the metal wires 86.

At this time, the heights of the bumps 64 are higher than the height of the photosensitive dry film 98 (the partitioning wall 42). Therefore, by joining the photosensitive dry film 98 (the partitioning wall 42) to the resin protective film 88, the bumps 64 are automatically joined to the metal wires 86. Namely, because it is easy to adjust the heights of the solder bumps 64 (the solder bumps 64 are easily crushed), the connecting of the bumps 64 and the sealing of the ink pooling chamber 38 by the photosensitive dry film 98 (the partitioning wall 42) can be carried out easily.

When the joining of the partitioning wall 42 and the resin protective film 88, and the joining of the bumps 64 and the metal wires 86, are completed, as shown in FIG. 10B, the resin material 58 for sealing (e.g., an epoxy resin) is injected-in at the driving ICs 60. Namely, the resin material 58 is made to flow-in from the injection openings 41 (see FIG. 5A) which are formed in the top plate 40. When the resin material 58 is injected-in and the driving ICs 60 are sealed in this way, the driving ICs 60 can be protected from the external environment such as moisture or the like, and the bonding strength of the piezoelectric element substrate 70 and the top plate 40 can be improved. Further, it is possible to avoid damage in the later steps, e.g., damage to the driving ICs 60 due to water or ground pieces at the time when the finished piezoelectric element substrate 70 is divided into the inkjet recording heads 32 by dicing.

Next, as shown in FIG. 1C, by injecting-in an adhesive removal solution from the through-holes 76A of the first supporting substrate 76 and selectively dissolving the adhesive 78 (see FIG. 10A), the first supporting substrate 76 is removed from the piezoelectric element substrate 70. In this way, as shown in FIG. 10D, the piezoelectric element substrate 70, with which the top plate 40 is united (joined), is completed. Then, from this state, the top plate 40 becomes the supporting body of the piezoelectric element substrate 70.

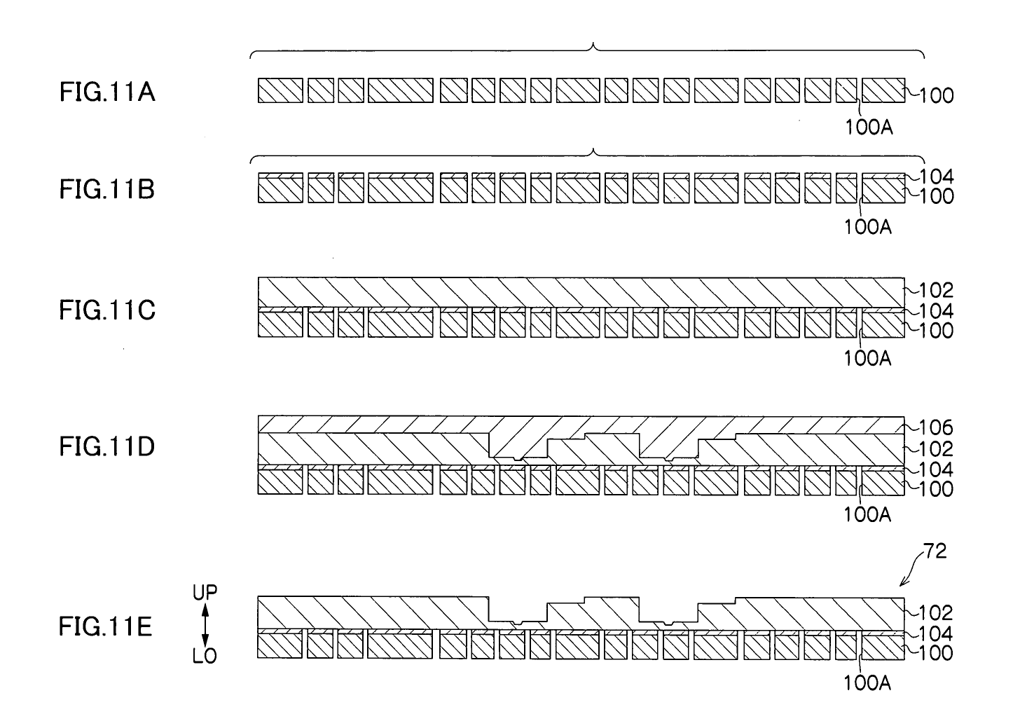

On the other hand, as shown in FIG. 11A, for the flow path substrate 72, first, a second supporting substrate 100 which is formed of glass and in which plural through-holes 100A are formed, is readied. In the same way as the first supporting substrate 76, the second supporting substrate 100 may be any material provided that it does not flex, and is not limited to being formed of glass, but glass is preferable as it is hard and inexpensive. Femtosecond laser machining of a glass substrate, exposure and development of a photosensitive glass substrate (e.g., PEG3C manufactured by Hoya Corporation), and the like are known as methods for fabricating the second supporting substrate 100.

Then, as shown in FIG. 11B, an adhesive 104 is coated on the top surface (the obverse) of the second supporting substrate 100. As shown in FIG. 1I C, a resin substrate 102 (e.g., an amideimide substrate of a thickness of 0.1 mm to 0.5 mm) is adhered to the top surface (the obverse) thereof. Then, as shown in FIG. 11D, the top surface of the resin substrate 102 is pushed against a mold 106, and heating and pressurizing processings are carried out. Thereafter, as shown in FIG. 11E, by separating the mold 106 from the resin substrate 102, the flow path substrate 72, in which the pressure chambers 50 and the nozzles 56 and the like are formed, is completed.

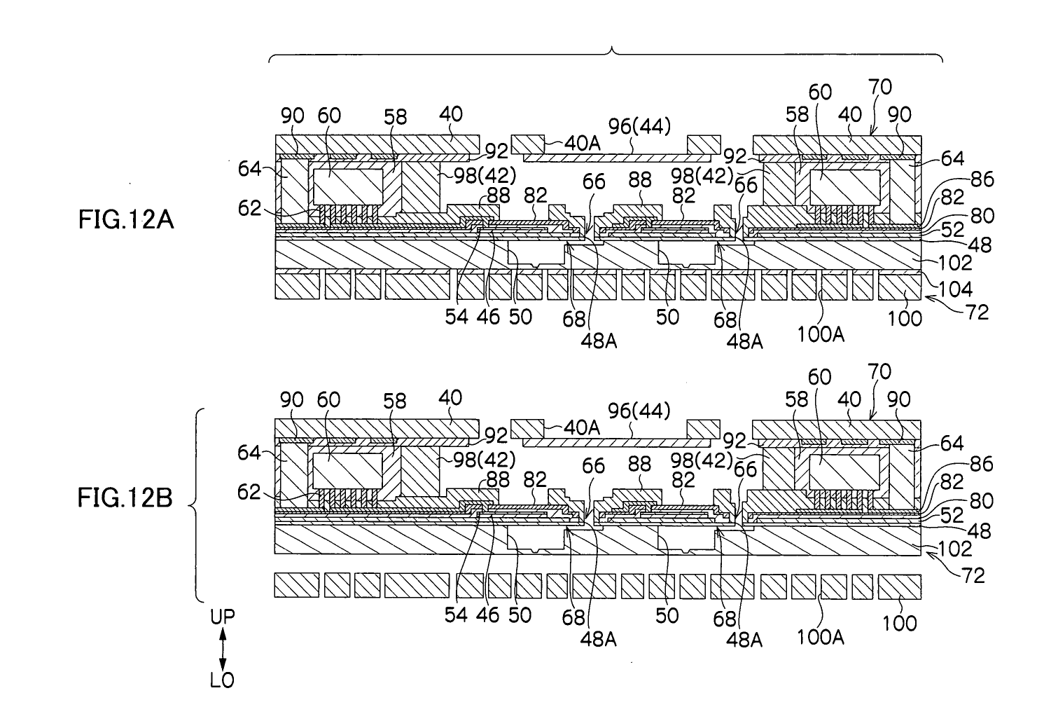

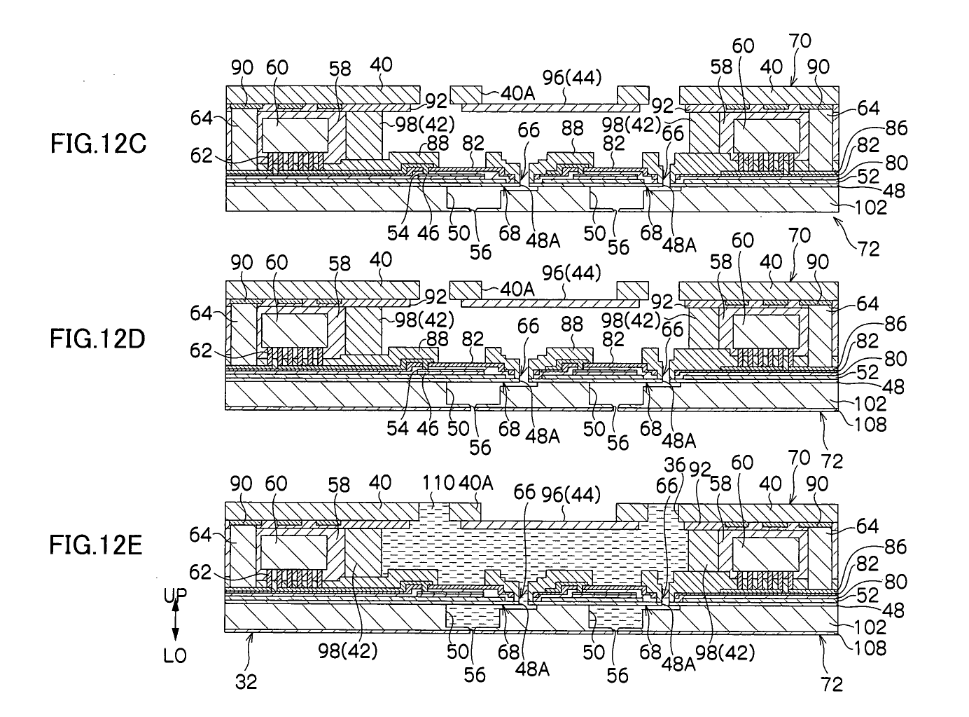

When the flow path substrate 72 is completed in this way, as shown in FIG. 12A, the piezoelectric element substrate 70 and the flow path substrate 72 are united (joined) by thermocompression bonding. Next, as shown in FIG. 12B, by injecting-in an adhesive removal solution from the through-holes 100A of the second supporting substrate 100 and selectively dissolving the adhesive 104, the second supporting substrate 100 is removed from the flow path substrate 72.

Thereafter, as shown in FIG. 12C, the surface from which the second supporting substrate 100 has been removed is subjected to polishing processing using an abrasive whose main component is alumina, or to RIE processing using oxygen plasma. In this way, the surface layer is removed, and the nozzles 56 are opened. Then, as shown in FIG. 12D, by applying a fluorine material 108 (e.g., Cytop manufactured by Asahi Glass Co., Ltd.), which serves as a water repellant, onto the bottom surface where the nozzles 56 are open, the inkjet recording head 32 is completed. As shown in FIG. 12E, the ink 110 can be filled into the ink pooling chamber 38 and the pressure chambers 50.

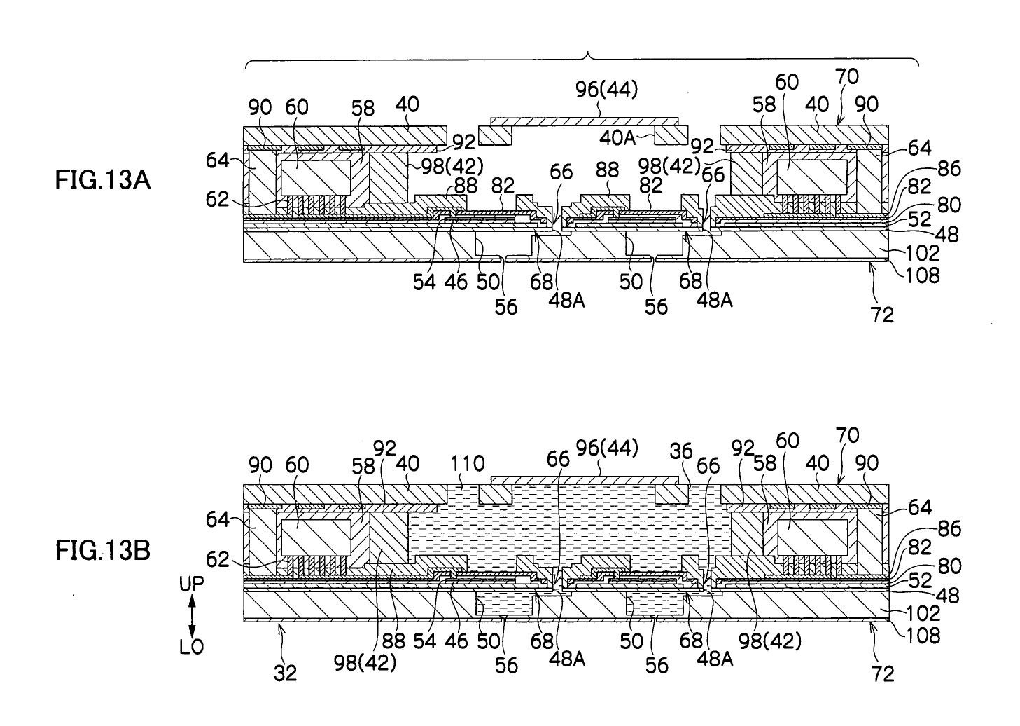

Note that the photosensitive dry film 96 (the air damper 44) is not limited to being provided within the ink pooling chamber 38 at the inner side of the top plate 40. For example, as shown in FIGS. 13A and 13B, the photosensitive dry film 96 (the air damper 44) may be provided at the outer side of the top plate 40. Namely, a structure may be used in which, immediately before the step of filling-in the ink 110, the photosensitive dry film 96 (the air damper 44) is affixed to the top plate 40 from the outer side of the ink pooling chamber 38.

Next, operation of the inkjet recording apparatus 10, which is provided with the inkjet recording head 32 which is manufactured as described above, will be described. First, when an electric signal instructing printing is sent to the inkjet recording apparatus 10, one of the recording papers P is picked-up from the paper feed tray 26, and is conveyed to a predetermined position by the subscanning mechanism 18.

On the other hand, at the inkjet recording unit 30, the ink 110 has already been injected-in (filled-in) in the ink pooling chamber 38 of the inkjet recording head 32 from the ink tank 34 and via the ink supplying ports 36. The ink 110 which is filled in the ink pooling chamber 38 is supplied to (filled into) the pressure chambers 50 via the ink flow paths 66, 68. At this time, a meniscus, in which the surface of the ink 110 is slightly concave toward the pressure chamber 50 side, is formed at the distal end (the ejecting opening) of the nozzle 56.

Then, while the inkjet recording heads 32, which are installed in the carriage 12, move in the main scanning direction, due to ink droplets being selectively ejected from the plural nozzles 56, a portion of the image based on the image data is recorded in a predetermined band region of the recording paper P. Namely, an ink ejecting command from the board 74 is transmitted to the driving ICs 60 via the metal wires 90, the bumps 64, and the metal wires 86. Then, voltage is applied to predetermined piezoelectric elements 46 at predetermined times by the driving ICs 60, the vibrating plate 48 is flexurally deformed in the top-bottom direction (is out-of-plane vibrated), pressure is applied to the ink 110 within the pressure chambers 50, and the ink 110 is ejected as ink droplets from predetermined nozzles 56.

When a portion of the image based on the image data is recorded on the recording paper P in this way, the recording paper P is conveyed a predetermined pitch by the subscanning mechanism 18. In the same way as described above, due to ink droplets being selectively ejected from the plural nozzles 56 again while the inkjet recording heads 32 move in the main scanning direction, a portion of the image based on the image data is recorded at the next band region of the recording paper P. When these operations are repeatedly carried out and the image based on the image data is completely recorded on the recording paper P, the subscanning mechanism 18 conveys the recording paper P to the end and discharges the recording paper P onto the catch tray 28. In this way, printing processing (image recording) onto the recording paper P is completed.

Here, at the inkjet recording head 32, the ink pooling chamber 38 is provided at the side opposite the pressure chambers 50 (the top side), with the vibrating plate 48 (the piezoelectric elements 46) therebetween. In other words, the vibrating plate 48 (the piezoelectric elements 46) is disposed between the ink pooling chamber 38 and the pressure chambers 50, and the ink pooling chamber 38 and the pressure chambers 50 do not exist on the same horizontal plane. Accordingly, the pressure chambers 50 are disposed near to one another, and the nozzles 56 are disposed in the form of a high-density matrix.

Further, the driving ICs 60, which apply voltage to the piezoelectric elements 46, are disposed between the vibrating plate 48 and the top plate 40, and are not exposed (do not project) further outwardly than the vibrating plate 48 and the top plate 40 (the driving ICs 60 are incorporated within the inkjet recording head 32). Accordingly, as compared with a case in which the driving ICs 60 are assembled on the exterior of the inkjet recording head 32, the lengths of the metal wires 86, which connect the piezoelectric elements 46 and the driving ICs 60, can be made to be short, and lowering of the resistance of and high-density connection of the metal wires 86 can thereby be realized. Namely, a high density of the nozzles 56 can be realized at a practical wire resistance value, and high resolution can be realized.

As described above, the metal wires 90, which are connected to the board 74 (see FIG. 6) which controls the ejecting of the ink, are formed on the top plate 40 of the ink pooling chamber 38. Further, these metal wires 90 and the metal wires 86, to which the driving ICs 60 are connected, are structured so as to be connected at the bumps 64 which are disposed between the vibrating plate 48 and the top plate 40. Therefore, the electrical connection can be carried out easily, and a flexible printed circuit board (FPC), which conventionally connected the driving ICs 60 and the board 74, and the like can be omitted. Namely, because the number of parts can be reduced by utilizing this structure, the inkjet recording head 32 can be made compact.

Specifically, in electrical connection by a conventional FPC method, the nozzle resolution was limited to 600 npi (nozzles per inch). However, in the system of the present invention, a 1200 npi array can be achieved easily. Further, when compared with, for example, the case of the 600 npi nozzle array, the size can be made to be ½ or less because it suffices to not use an FPC.

Because the metal wires are covered by the resin film 92, corrosion of the metal wires 90 due to the ink is prevented. Moreover, because the air damper 44 is provided at the top plate 40 as described above, the size, the position, and the like of the air damper 44 can be changed freely. Namely, it is easy to optimize the air damper 44. Further, for this reason, degrees of freedom in leading-around the metal wires 90 formed at the top plate 40 can be improved.

In any case, the piezoelectric element substrate 70 and the flow path substrate 72, which structure the inkjet recording head 32, are manufactured respectively on the supporting substrates 76, 100 which are always hard. In these manufacturing processes, a manufacturing method is used in which the supporting substrates 76, 100 are removed at the point in time when they become unnecessary. Therefore, the inkjet recording head 32 is a structure which is very easy to manufacture. Note that the rigidity of the manufactured (completed) inkjet recording head 32 is ensured, because the inkjet recording head 32 is supported by the top plate 40 (the top plate 40 is used as a supporting body).

### Second Embodiment

A second embodiment will be described next. Here, a case in which a top plate which is made of resin is used will be described. Description of contents which are substantially the same as those of the first embodiment will be omitted.

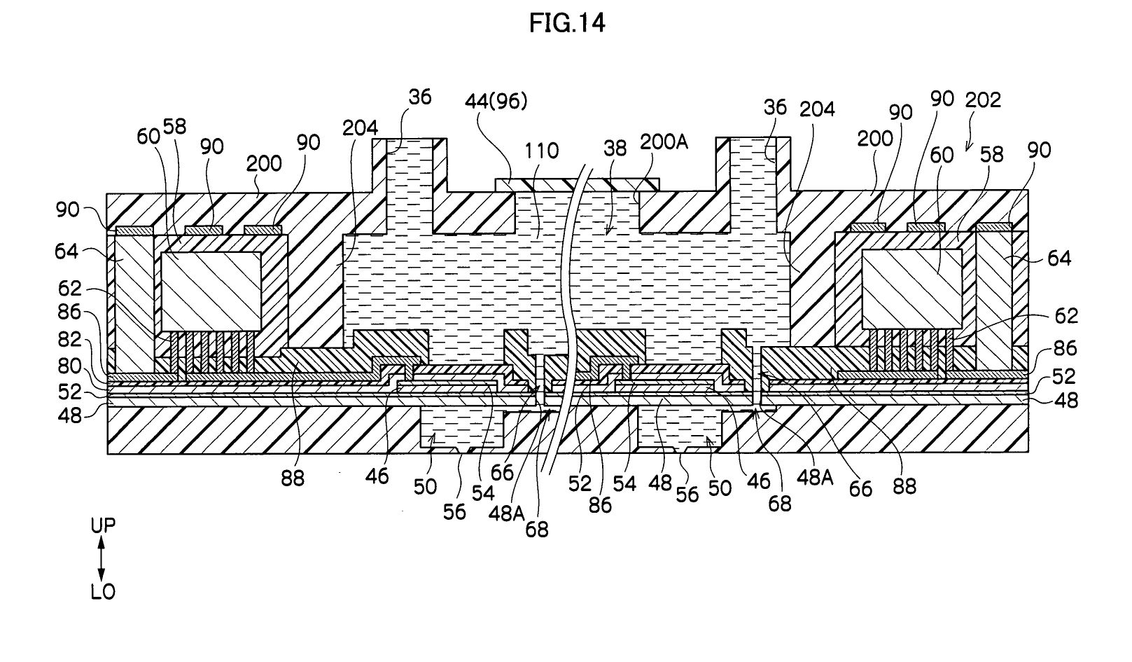

FIG. 14 is a schematic sectional view taken along line X-X of FIG. 3. A top plate 200 is molded of polyphenylene sulfide for example, and may be any resin provided that it is a resin having strength such that the top plate 200 can become the supporting body of an inkjet recording head 202. The top plate 200 also may be molded of polysulfone, polyacetal, polyimide, polypropylene, polyethylene, polycarbonate, or the like.

The metal wires 90, which are for energizing the driving ICs 60 as will be described later, are formed integrally with the top plate 200 by a three-dimensional wiring forming process (to be described later). In the three-dimensional wiring forming process, a molded part and a wire part are made integral. By molding the top plate 200 of resin and making the metal wires 90 integral with this resin top plate 200, full three-dimensionality is achieved, the number of parts can be reduced, and accompanying the reduction in the number of parts, the inkjet recording head can be made to be more compact, more lightweight, and less expensive. Moreover, a partitioning wall 204 is molded integrally with the top plate 200, and hangs down from the bottom surface of the top plate 200.

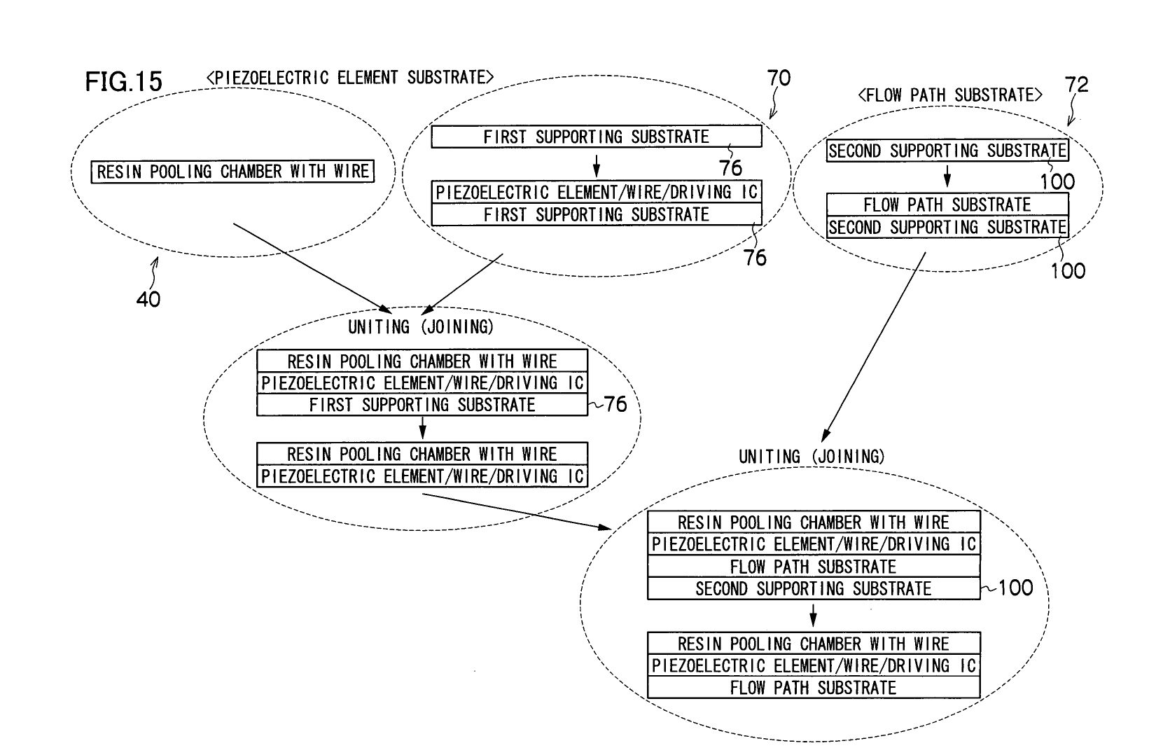

The processes of manufacturing the inkjet recording head 202 having the above-described structure will be described in detail on the basis of FIG. 15 through FIGS. 19A and 19B.

As shown in FIG. 15, the inkjet recording head 202 is manufactured by forming the piezoelectric element substrate 70 and the flow path substrate 72 separately, and uniting (joining) the two together. The top plate 200 is united (joined) to the piezoelectric element substrate 70 before the flow path substrate 72. Note that description of the processes of manufacturing the piezoelectric element substrate 70 will be omitted as they are the same as in the first embodiment.

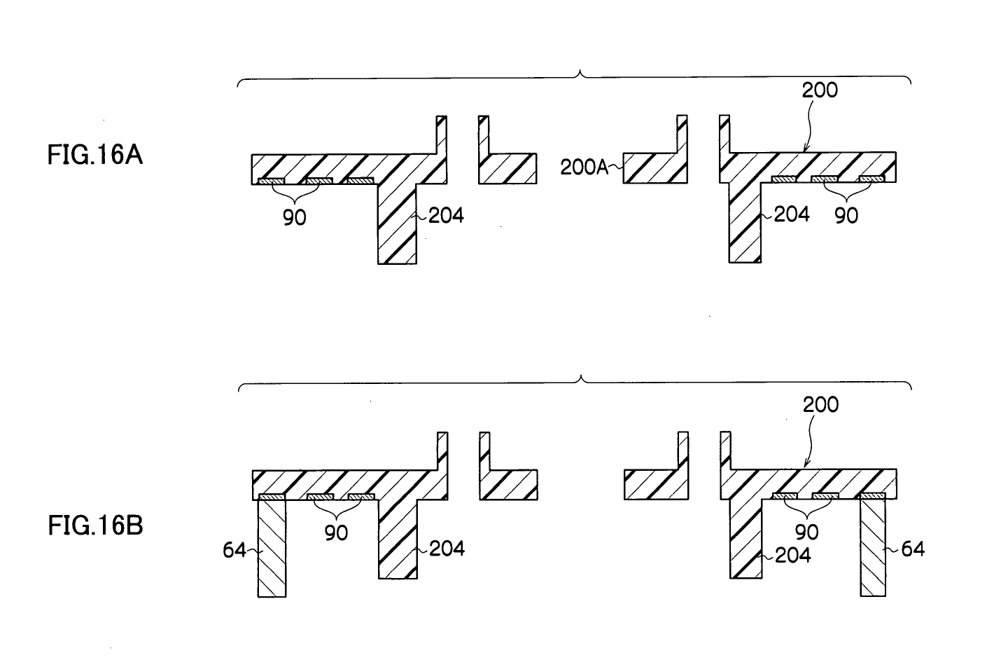

In manufacturing the top plate 200, as shown in FIG. 16A, because the top plate 200 itself has a thickness (1 mm to 3 mm) which can ensure strength of an extent needed for the top plate 200 to be a supporting body, there is no need to provide a separate supporting body. The partitioning wall 204 is integrally molded with the top plate 200 in a state of hanging downward from the bottom surface of the top plate 200. The metal wires 90 are formed by the three-dimensional wiring forming process at the bottom surface of the top plate 200.

Here, the part in which the wires are formed at the resin molded product by the three-dimensional wiring forming process is called an MID (molded interconnect device: three-dimensional injection-molded circuit component), and satisfies the following conditions: (1) it is a resin molded part; (2) it has a three-dimensional shape; and (3) it has a three-dimensional wire pattern. Namely, it is a part in which a wire pattern is formed on a three-dimensional resin molded part.

Processes for manufacturing MIDs can be broadly classified into a single-molding process called a one-shot process, a double-molding process called a two-shot process, and a hot stamping process which does not use plating.

In the one-shot process, the MID is manufactured in the following order for example: formation of an Au plating film→coating of a photoresist→exposure by a three-dimensional exposure device using a DMD (digital micromirror device)→wet etching of the Au thin film by aqua regia→removal of the resist (photolithography of a three-dimensional structure).

In the two-shot process, wire portions are formed by plating grade resin at the time of primary molding, and insulating portions are formed by non-plating grade resin at the time of secondary molding. Depending on the configuration, there are also cases in which a non-plating grade resin is used in the primary molding and a plating grade resin is used in the secondary molding.

The hot stamping process is a method of forming a circuit on a resin molded product without using plating. An electrical circuit is formed directly on the resin molded product by IVOTAPE (a copper paper made by electrolysis).

As shown in FIG. 16B, the bumps 64 are formed by plating or the like at the metal wires 90 which are disposed at positions away from the partitioning wall 204 of the top plate 200. As illustrated, these bumps 64 are formed so as to be longer than the partitioning wall 204, in order to be connected electrically to the metal wires 86 at the driving ICs 60.

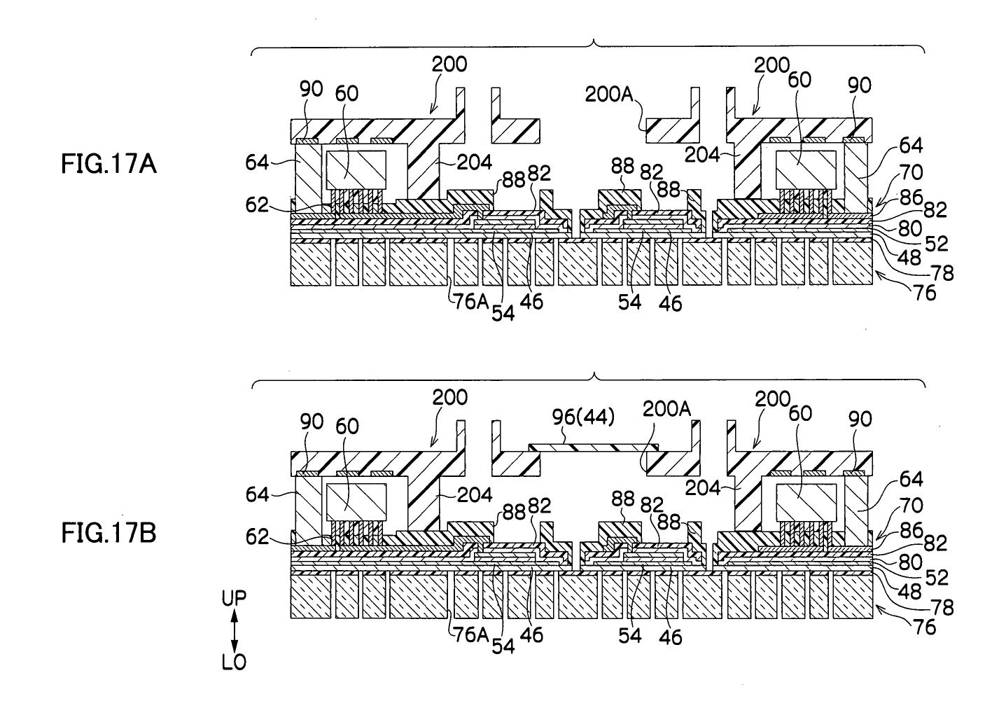

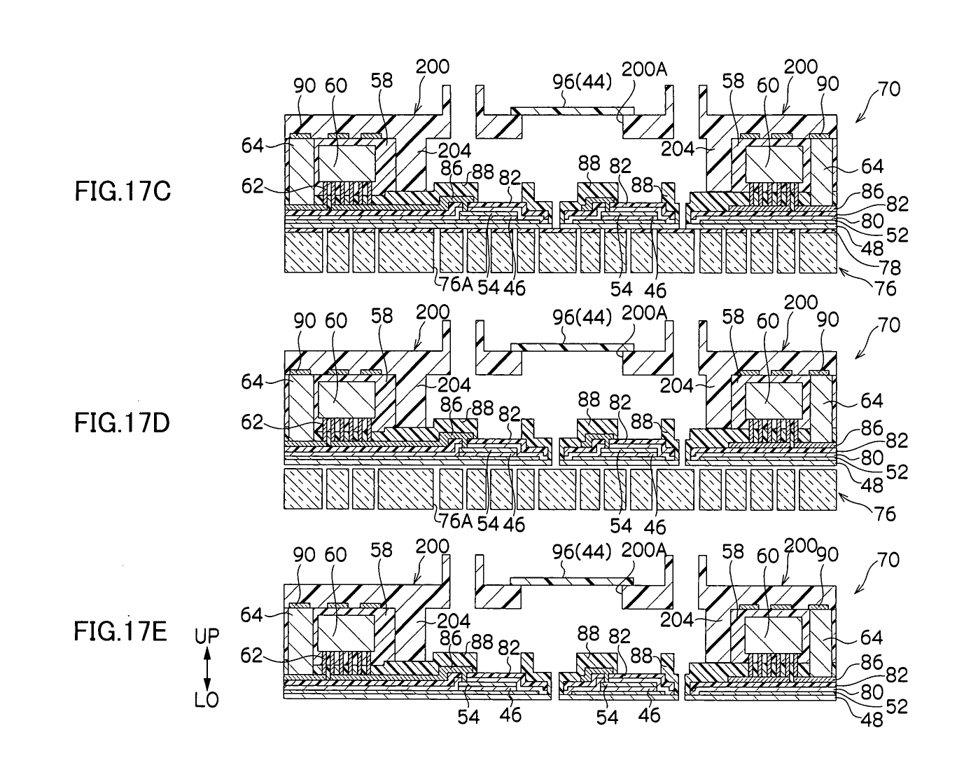

After the top plate 200 is manufactured in this way, as shown in FIG. 17A, the top plate 200 is placed on the piezoelectric element substrate 70, and the both are united (joined) together by thermocompression bonding. Namely, the partitioning wall 204 is joined to the resin protective film 88 which is a photosensitive resin layer, and the bumps 64 are joined to the metal wires 86.

When the joining of the partitioning wall 204 and the resin protective film 88, and the joining of the bumps 64 and the metal wires 86, are completed, as shown in FIG. 17B, the outer edge portion of the photosensitive dry film 96 (e.g., Raytec FR-5025 manufactured by Hitachi Chemical Co., Ltd., thickness: 25 μm) is affixed to the peripheral edge portion of an opening 200A formed in the top plate 40, so as to close the opening 200A. This photosensitive dry film 96 becomes the air damper 44 which mitigates pressure waves.

Next, as shown in FIG. 17C, the resin material 58 for sealing (e.g., an epoxy resin) is injected-in around the driving ICs 60. Namely, the injection openings 41 (see FIG. 5A) are formed in the top plate 200, and the resin material 58 is made to flow-in from these injection openings 41.

When the resin material 58 is injected-in at the peripheries of the driving ICs 60 and the driving ICs 60 are sealed in this way, erosion of the metal wires 90 due to the ink 110 is prevented. Further, the driving ICs 60 can be protected from the external environment such as moisture or the like, and the bonding strength of the piezoelectric element substrate 70 and the top plate 200 can be improved. Further, it is possible to avoid damage in the later steps, e.g., damage due to water or ground pieces at the time when the finished piezoelectric element substrate 70 is divided into the inkjet recording heads 202 by dicing.

Next, as shown in FIG. 17D, by injecting-in an adhesive removal solution from the through-holes 76A of the first supporting substrate 76 and selectively dissolving the adhesive 78, the first supporting substrate 76 is removed from the piezoelectric element substrate 70. In this way, as shown in FIG. 17E, the piezoelectric element substrate 70, with which the top plate 200 is united (joined), is completed. Then, from this state, the top plate 200 becomes the supporting body of the piezoelectric element substrate 70.

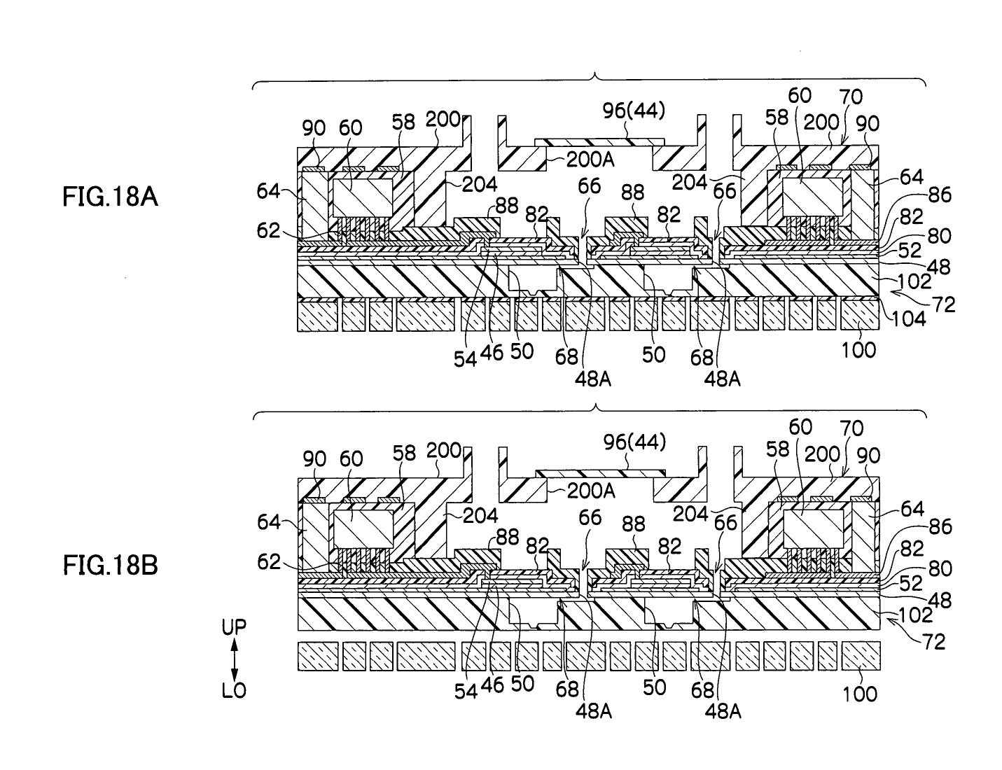

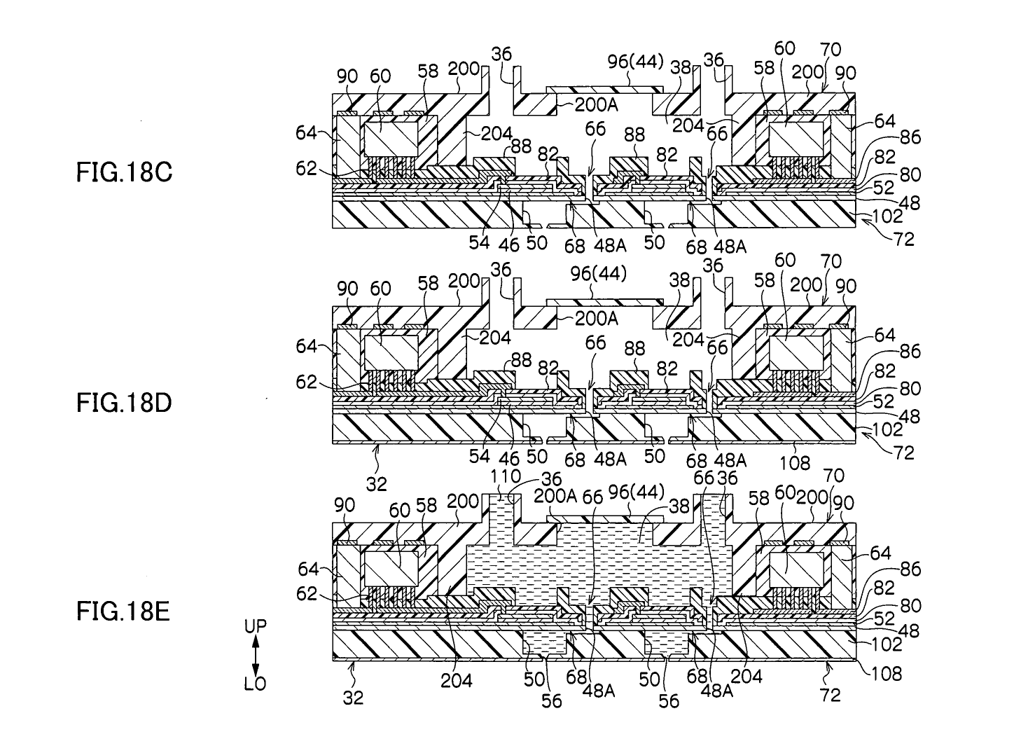

Because the processes of manufacturing the flow path substrate 72 are the same as in the first embodiment, description thereof will be omitted. When the flow path substrate 72 is completed, as shown in FIG. 18A, the piezoelectric element substrate 70 and the flow path substrate 72 are united (thermally bonded) by thermocompression bonding. Next, as shown in FIG. 18B, by injecting-in an adhesive removal solution from the through-holes 100A of the second supporting substrate 100 and selectively dissolving the adhesive 104, the second supporting substrate 100 is removed from the flow path substrate 72.

Thereafter, as shown in FIG. 18C, the surface from which the second supporting substrate 100 has been removed is subjected to polishing processing using an abrasive whose main component is alumina, or to RIE processing using oxygen plasma. In this way, the surface layer is removed, and the nozzles 56 are opened. Then, as shown in FIG. 18D, by applying the fluorine material 108 (e.g., Cytop manufactured by Asahi Glass Co., Ltd.), which serves as a water repellant, onto the bottom surface where the nozzles 56 are open, the inkjet recording head 202 is completed. As shown in FIG. 18E, the ink 110 can be filled into the ink pooling chamber 38 and the pressure chambers 50.

Here, the opening 200A is formed in the top plate 200, and by affixing the outer edge portion of the photosensitive dry film 96 to the peripheral edge portion of the opening 200A, the opening 200A is closed and the air damper 44 is formed. However, the present invention is not limited to the same.

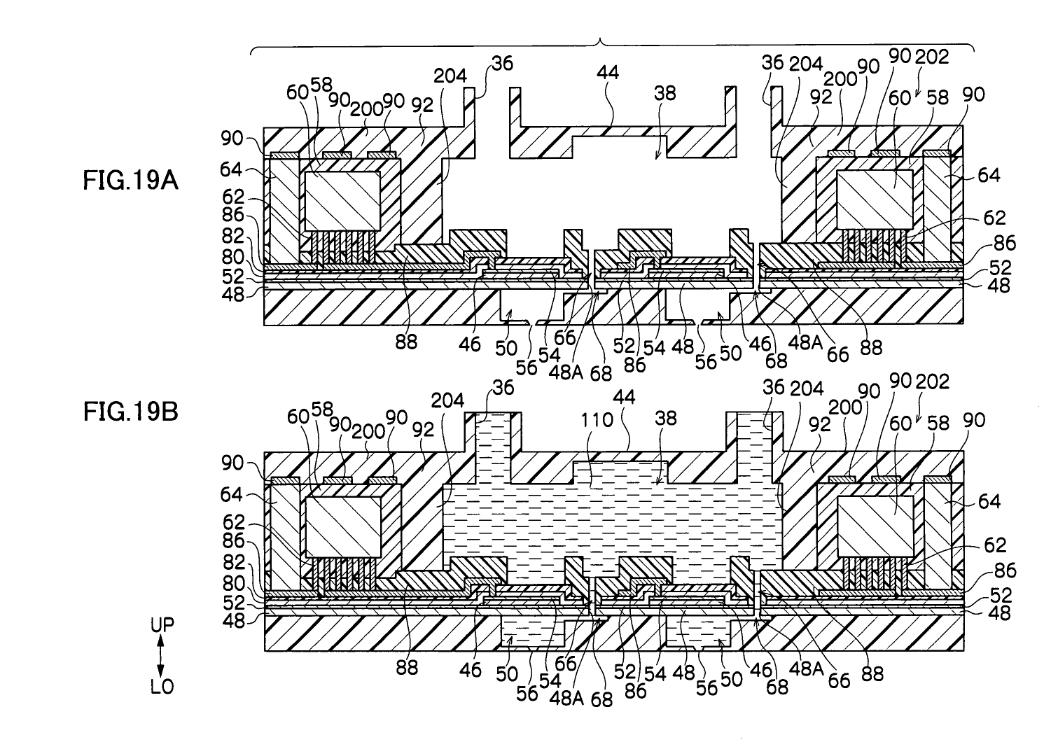

For example, the air damper 44 may be structured by patterning, by exposure and development, the photosensitive dry film 96 at the opening 200A portion. Or, as shown in FIGS. 19A and 19B, a thin-walled portion may be molded integrally with the top plate 200, and the air damper 44 may be structured by this thin-walled portion. In this case, as compared with a case in which the air damper 44 is provided separately, the cost can be reduced because there is no need to provide the opening 200A for forming the air damper 44 at the top plate 200 and the process of forming the air damper 44 is unnecessary.

As described above, in the second embodiment, the top plate 200 of the ink pooling chamber 38 is a so-called MID (three-dimensional injection-molded circuit component), and the metal wires 90 are formed at the bottom surface of the top plate 200. In an MID, it is possible to fuse and integrate an electronic part and a mechanism part, which had been difficult conventionally. By utilizing an organic material called a liquid crystal polymer, this technique can provide a three-dimensional molded substrate having excellent moldability, suitable mechanical strength, and heat-resistance to the extent that solder assembling is possible.

The following effects are thereby obtained:
(1) multi-functionality is achieved due to the integration of the circuit board and the structure;
(2) by using a liquid crystal polymer, the top plate 200 has heat-resistance to the extent that solder assembling is possible;
(3) the number of parts is reduced due to the integral molding of the structure attached to the substrate;
(4) the inkjet recording head is made more compact and lighter-weight due to the optimal design in three dimensions; and
(5) assembly costs are reduced due to the decrease in the number of parts, the streamlining of the assembly processes, and the automation.

Namely, even if the density of the nozzles is high, wires having desired low resistance values can be led around, such that an increase in the density of the nozzles 56, and an accompanying increase in resolution, can be achieved. Further, a part such as an FPC or the like is not needed in order to be able to form the metal wires 90 at the top plate 200. This can contribute to making the inkjet recording head 202 more compact, and a lighter weight and a lower cost can be realized. Moreover, by molding the top plate 200 of resin, the cost can be reduced as compared with the case of using a glass top plate.

By molding the partitioning wall 204 of the ink pooling chamber 38 integrally with the top plate 200, the cost can be reduced as compared with a case in which the partitioning wall 204 is formed separately by patterning. Further, because the partitioning wall 204 and the piezoelectric element substrate 70 are made integral by thermocompression bonding the partitioning wall 204 to the resin protective film 88 of the piezoelectric element substrate 70, penetration of ink at the surfaces thereof which are joined together can be prevented.

On the other hand, the bumps 64, which electrically connect the metal wires 90 and the metal wires 86, are formed to be longer than the partitioning wall 204. By joining the partitioning wall 204 to the resin protective film 88, the bumps 64 are automatically joined to the metal wires 86. Namely, because it is easy to adjust the heights of the solder bumps 64 (the solder bumps 64 are easily crushed), the sealing of the ink pooling chamber 38 by the partitioning wall 204 and the electrical connecting of the metal wires 90 and the metal wires 86 can be carried out simultaneously by making the bumps 64 longer than the partitioning wall 204.

Further, the driving ICs 60, which apply voltage to the piezoelectric elements 46, are flip-chip assembled on the piezoelectric element substrate 70 at which the piezoelectric elements 46 and the like are formed on the vibrating plate 48. Therefore, high-density wire connection can be accomplished easily, and the heights of the driving ICs 60 can be reduced (the driving ICs 60 can be made thinner). Accordingly, the inkjet recording head 202 can be made more compact as well.

Further, because the gaps around the driving ICs 60 are filled-in by the resin material 58, the bond strength between the top plate 200 and the piezoelectric element substrate 70 increases. Moreover, because the driving ICs 60 are sealed by the resin material 58, the driving ICs 60 can be protected from the external environment such as moisture and the like. Further, it is possible to avoid damage in the later steps, e.g., damage due to water or ground pieces at the time when the finished piezoelectric element substrate 70 is divided into the inkjet recording heads 202 by dicing.

### Third Embodiment

A third embodiment will be described next. Here, a case in which the top plate and the partitioning wall are molded separately and of resin respectively will be described. Description of contents which are substantially the same as those of the first embodiment or the second embodiment will be omitted.

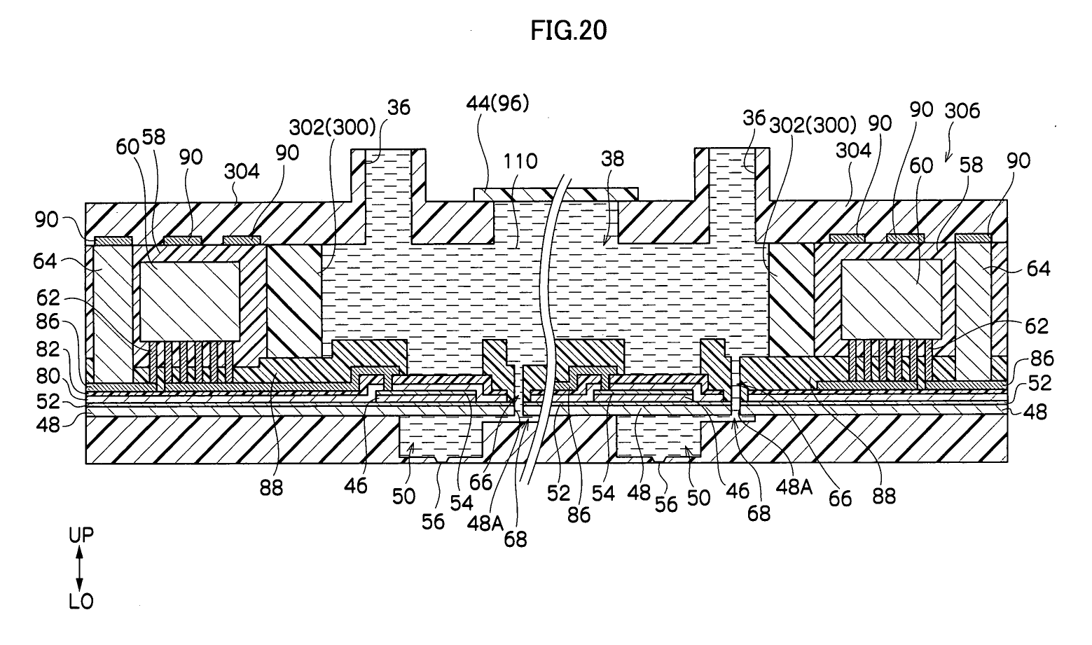

FIG. 20 is a schematic sectional view taken along line X-X of FIG. 3. The processes of manufacturing an inkjet recording head 306 of this structure will be described.

First, the processes of fabricating the piezoelectric element substrate 70 will be described. Because the processes from FIG. 8A up to FIG. 8I are the same as those of the first embodiment, description thereof will be omitted.

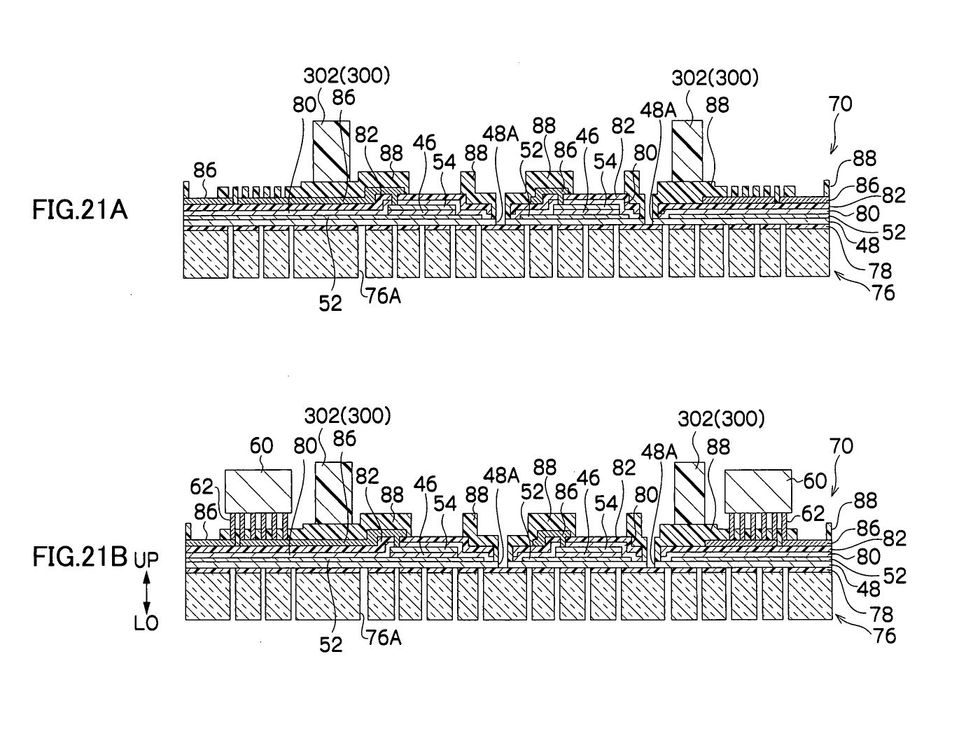

In FIG. 8I, the resin protective film 88 (e.g., the photosensitive polyimide Durimide 7320 manufactured by FUJIFILM Electronics Materials Co., Ltd.) is layered on the top surfaces of the metal wires 86 and the resin film 82, and is patterned. Thereafter, as shown in FIG. 21A, a photosensitive dry film 300 (thickness: 100 μm) is layered on the top surface of the resin protective film 88, and is patterned by exposure and development. This photosensitive dry film 300 becomes a partitioning wall 302 which prescribes the ink pooling chamber 38.

Note that the partitioning wall 302 is not limited to the photosensitive dry film 300, and may be a resin coated film (e.g., SU-8 resist manufactured by Kayaku Microchem Corporation). At this time, it suffices for coating to be carried out by a spray coating device, and for exposure and development to be carried out.

Next, as shown in FIG. 21B, the driving ICs 60 are flip-chip assembled on the metal wires 86 via the bumps 62. At this time, the driving ICs 60 are worked to a predetermined thickness (70 μm to 300 μm) in a grinding process carried out in advance at the end of the semiconductor wafer processes. If the driving ICs 60 are too thick, patterning of the partitioning wall 302 and formation of the bumps 64 are difficult.

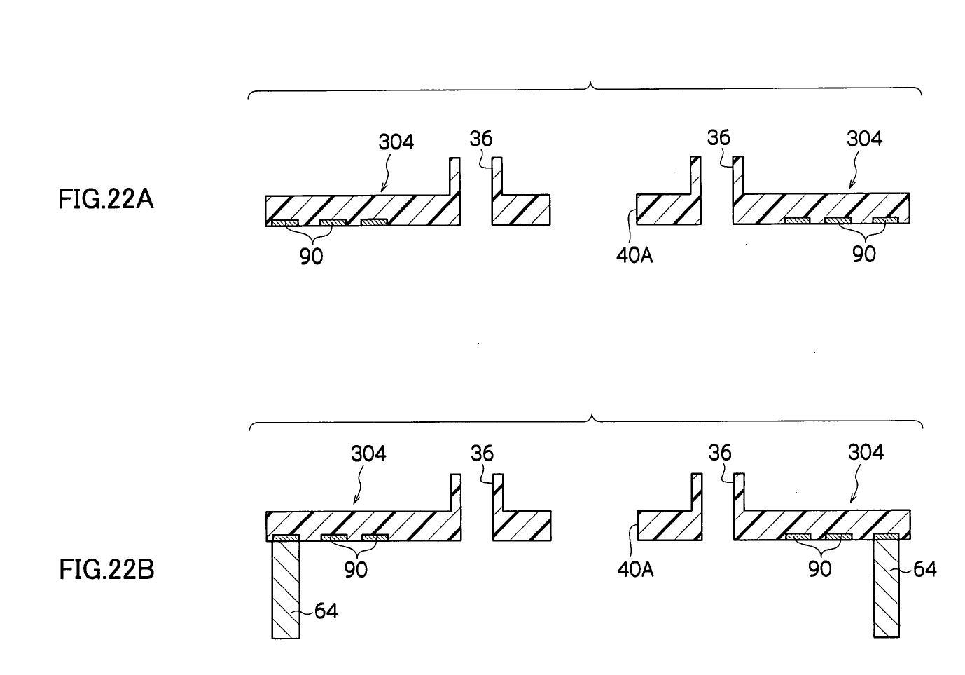

Electroplating, electroless plating, a ball bump process, screen printing, or the like can be used as the method for forming the bumps 62 for flip-chip assembling the driving ICs 60 on the metal wires 86. In this way, the piezoelectric element substrate 70 is fabricated, and a top plate 304, which is made of resin, is united (joined) thereto. Note that, for convenience of explanation, in FIG. 22 to be described hereinafter, description is given with the wire formation surface being the bottom surface, but the wire formation surface is the top surface in the actual processes.

In manufacturing the top plate 304, as shown in FIG. 22A, the top plate 304 itself has a thickness (1 mm to 3 mm) which can ensure strength of an extent needed for the top plate 304 to be a supporting body. Therefore, there is no need to provide a separate supporting body. Further, the metal wires 90 are formed at the bottom surface of the top plate 304 by the three-dimensional wiring forming process.

Then, as shown in FIG. 22B, the bumps 64 are formed by plating or the like at the metal wires 90 which are disposed at the outer peripheral sides of the top plate 304. In order to be electrically connected with the metal wires 86 at the driving ICs 60, these bumps 64 are formed so as to be longer than the partitioning wall 302 (see FIG. 21A). This will be described in detail later.

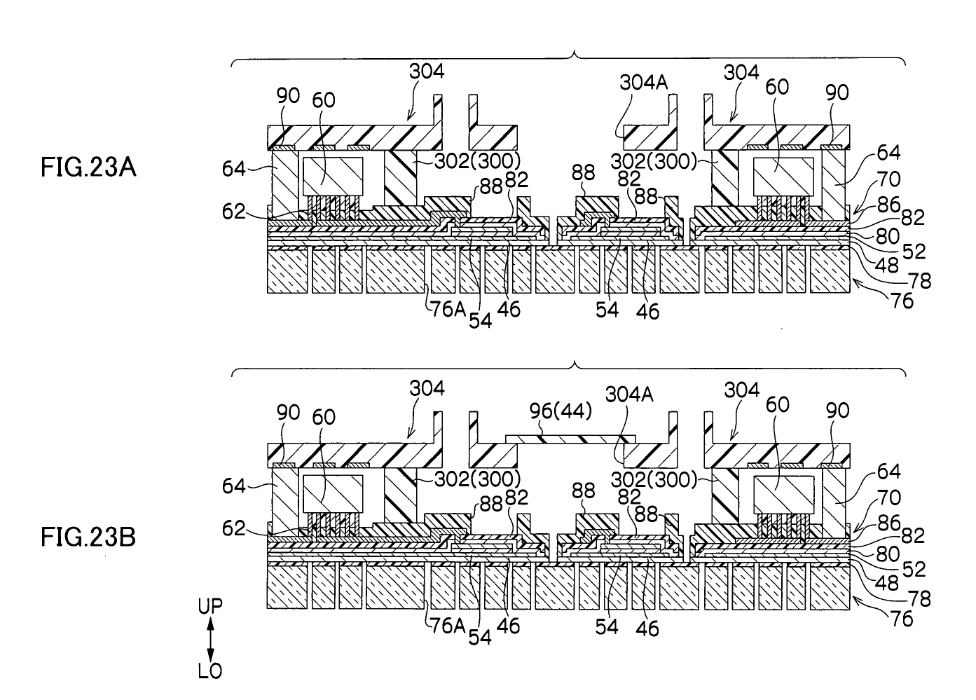

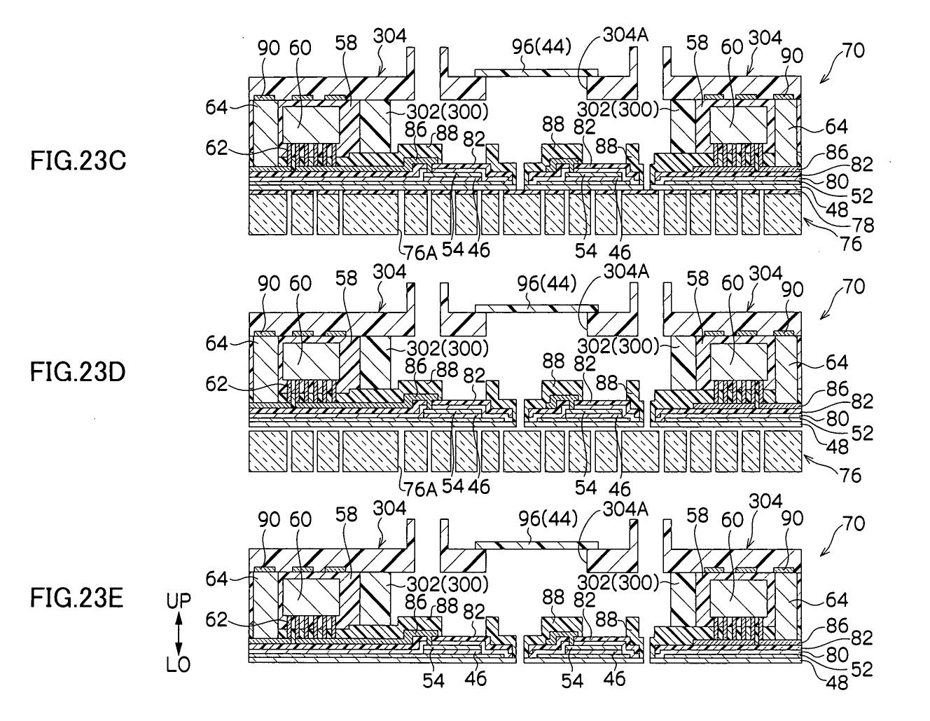

After the top plate 304 is manufactured in this way, as shown in FIG. 23A, the top plate 304 is placed on the piezoelectric element substrate 70, and the both are united (thermally bonded) together by thermocompression bonding. Namely, the top plate 304 is joined to the partitioning wall 302, and the bumps 64 are joined to the metal wires 86.

When the joining of the top plate 304 and the partitioning wall 302, and the joining of the bumps 64 and the metal wires 86, are completed, as shown in FIG. 23B, the outer edge portion of the photosensitive dry film 96 (e.g., Raytec FR-5025 manufactured by Hitachi Chemical Co., Ltd., thickness: 25 μm) is affixed to the peripheral edge portion of an opening 304A formed in the top plate 304, so as to close the opening 304A. This photosensitive dry film 96 becomes the air damper 44 which mitigates pressure waves.

Next, as shown in FIG. 23C, the resin material 58 for sealing (e.g., an epoxy resin) is injected-in at the peripheries of the driving ICs 60. Namely, the resin material 58 is made to flow-in from the injection openings 41 (see FIG. 5A) which are formed in the top plate 304.

Then, as shown in FIG. 23D, by injecting-in an adhesive removal solution from the through-holes 76A of the first supporting substrate 76 and selectively dissolving the adhesive 78, the first supporting substrate 76 is removed from the piezoelectric element substrate 70. In this way, as shown in FIG. 23E, the piezoelectric element substrate 70, with which the top plate 304 is united (joined), is completed. Then, from this state, the top plate 304 becomes the supporting body of the piezoelectric element substrate 70.

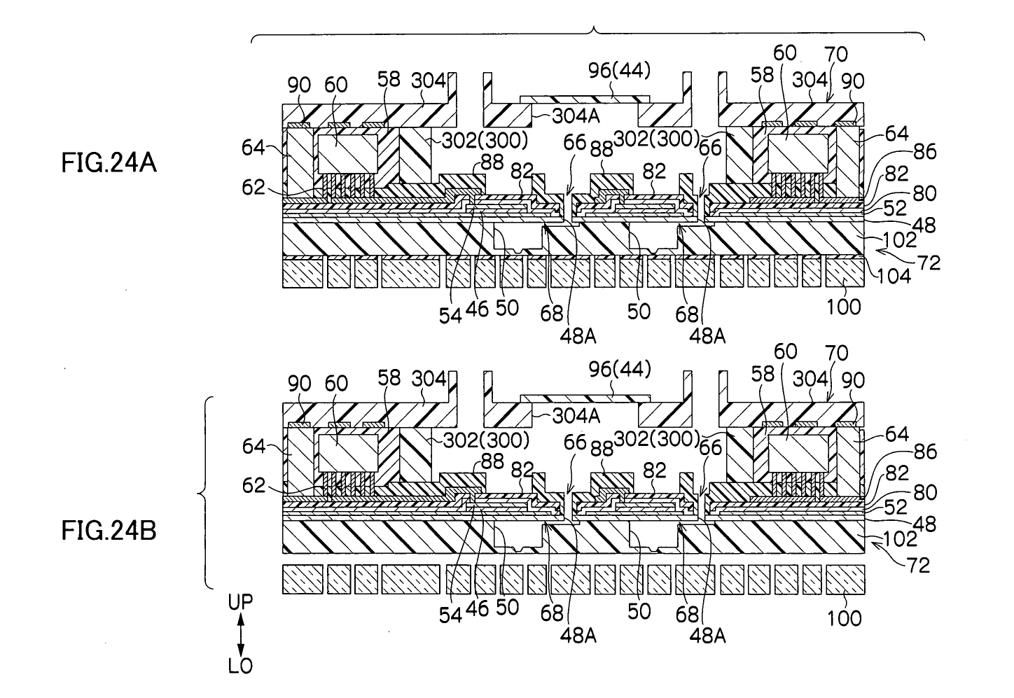

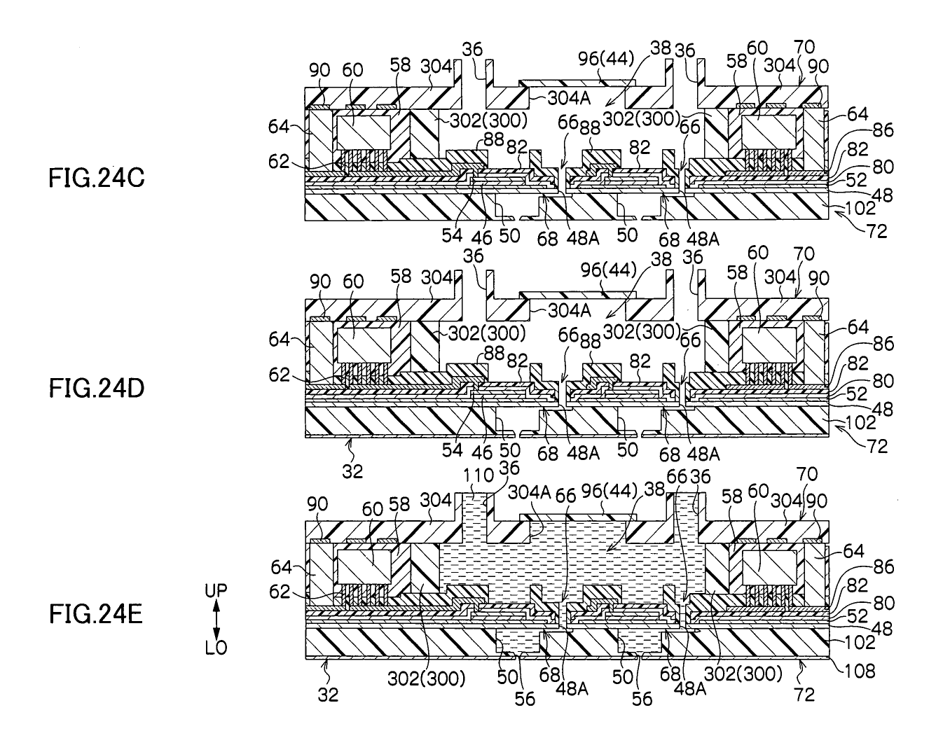

Because the processes of manufacturing the flow path substrate 72 are the same as in the first embodiment, description thereof will be omitted. When the flow path substrate 72 is completed, as shown in FIG. 24A, in the same way as in the second embodiment, the piezoelectric element substrate 70 and the flow path substrate 72 are united (thermally bonded) by thermocompression bonding.

Next, as shown in FIG. 24B, by injecting-in an adhesive removal solution from the through-holes 100A of the second supporting substrate 100 and selectively dissolving the adhesive 104, the second supporting substrate 100 is removed from the flow path substrate 72.

Thereafter, as shown in FIG. 24C, the surface from which the second supporting substrate 100 has been removed is subjected to polishing processing using an abrasive whose main component is alumina, or to RIE processing using oxygen plasma. In this way, the surface layer is removed, and the nozzles 56 are opened.

Then, as shown in FIG. 24D, by applying the fluorine material 108 (e.g., Cytop manufactured by Asahi Glass Co., Ltd.), which serves as a water repellant, onto the bottom surface where the nozzles 56 are open, the inkjet recording head 306 is completed. As shown in FIG. 24E, the ink 110 can be filled into the ink pooling chamber 38 and the pressure chambers 50.

In the present embodiment, by separately fabricating the partitioning wall 302 and the top plate 304 which structure the ink pooling chamber 38, the shapes of the top plate 304 and the partitioning wall 302 can be simplified. Further, as compared with a case in which the top plate 304 and the partitioning wall 302 are molded integrally, because it is easy for the partitioning wall 302 to be crushed at the time of joining, the joining-together with the top plate 304 is good, and the ink sealability improves. (In a structure in which the top plate 304 and the partitioning wall 302 are molded integrally, the joining surface is the top surface of the resin protective film 88. However, in this case, the partitioning wall, which is hard and is formed by molding, and the resin protective film 88, which is thin in the direction in which pressure is applied, are both difficult to crush, and therefore, the joining force deteriorates.)

Here, the opening 304A is formed in the top plate 304, and by affixing the outer edge portion of the photosensitive dry film 96 to the peripheral edge portion of the opening 304A, the opening 304A is closed and the air damper 44 is formed. However, the air damper 44 may be structured by patterning the photosensitive dry film 96 by exposure and development at the opening 304A portion.

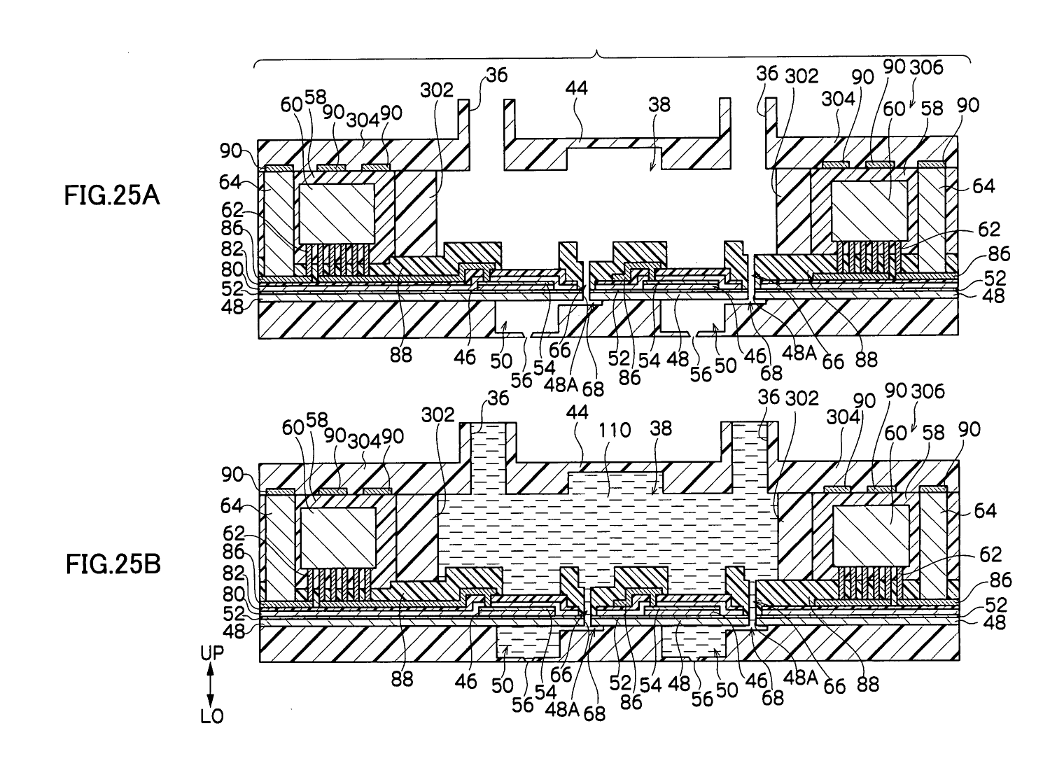

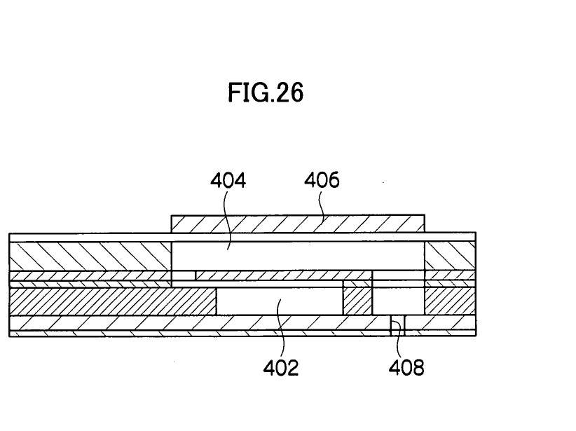

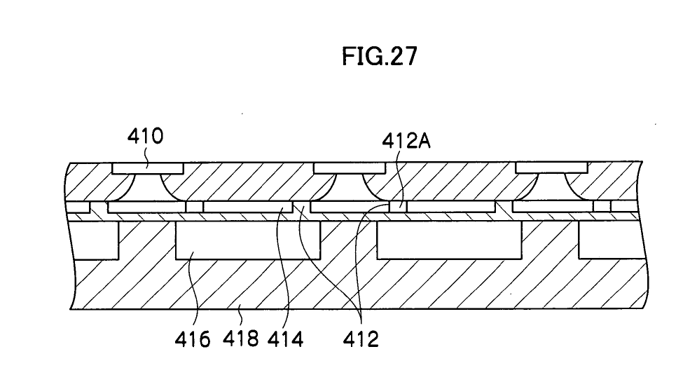

Further, as shown in FIGS. 25A and 25B, a thin-walled portion may be molded integrally with the top plate 304, and the air damper 44 may be formed by this thin-walled portion. In this case, as compared with a case in which the air damper 44 is provided separately, there is no need to provide the opening 304A for forming the air damper 44 in the top plate 304, and the process for forming the air damper 44 is unnecessary. Therefore, costs can be reduced.

In the inkjet recording apparatus 10 of the above-described embodiments, the inkjet recording units 30 of the respective colors of black, yellow, magenta, and cyan are respectively installed in the carriage 12, and on the basis of image data, ink droplets are selectively ejected from the inkjet recording heads 32 (202, 306) of these respective colors such that a full-color image is recorded on the recording paper P. However, the inkjet recording in the present invention is not limited to the recording of characters or images onto the recording paper P.

Namely, the recording medium is not limited to paper, and the liquid which is ejected is not limited to ink. For example, the inkjet recording head 32 relating to the present invention can be applied to liquid drop jetting devices in general which are used industrially, such as in fabricating color filters for displays by ejecting ink onto a high polymer film or glass, or in forming bumps for parts assembly by ejecting solder in a welded state onto a substrate, or the like.

Further, in the inkjet recording apparatus 10 of the above-described embodiments, a Partial Width Array (PWA) having the main scanning mechanism 16 and the subscanning mechanism 18 is described as an example. However, the inkjet recording in the present invention is not limited to the same, and may be so-called Full Width Array (FWA) which corresponds to the width of the paper. Because the present invention is effective in realizing a high-density nozzle array, it is ideal for FWA which necessitates single-pass printing.

1. An inkjet recording head comprising:
a nozzle ejecting ink droplets;
a pressure chamber which communicates with the nozzle and in which ink is filled;
a vibrating plate structuring a portion of the pressure chamber;
an ink pooling chamber pooling ink to be supplied to the pressure chamber via an ink flow path;
a piezoelectric element displacing the vibrating plate; and
a driving IC provided on a same substrate as the piezoelectric element, and applying voltage to the piezoelectric element,
wherein a first wire for energizing the driving IC is formed at a top plate of the ink pooling chamber which is provided at a side of the vibrating plate opposite a side at which the pressure chamber is provided.

2. The inkjet recording head of claim 1, wherein the ink pooling chamber is structured by:
a piezoelectric element substrate which is formed so as to include the vibrating plate and at which the piezoelectric element is provided;
the top plate; and
a partitioning wall supporting the top plate.

3. The inkjet recording head of claim 1, wherein the first wire and the driving IC are connected at a bump which is disposed between the piezoelectric element substrate and the top plate.

4. The inkjet recording head of claim 2, wherein the first wire and the driving IC are connected at a bump which is disposed between the piezoelectric element substrate and the top plate.

5. The inkjet recording head of claim 1, wherein the nozzles are disposed in a form of a matrix.

6. The inkjet recording head of claim 1, wherein the ink pooling chamber has an ink supplying opening supplying ink, and an air damper absorbing pressure waves of the ink pooled in the ink pooling chamber, and the air damper is provided at the top plate.

7. The inkjet recording head of claim 2, wherein the ink pooling chamber has an ink supplying opening supplying ink, and an air damper absorbing pressure waves of the ink pooled in the ink pooling chamber, and the air damper is provided at the top plate.

8. The inkjet recording head of claim 3, wherein the ink pooling chamber has an ink supplying opening supplying ink, and an air damper absorbing pressure waves of the ink pooled in the ink pooling chamber, and the air damper is provided at the top plate.

9. The inkjet recording head of claim 1, wherein the top plate is formed of glass.

10. The inkjet recording head of claim 1, wherein the first wire is covered by a resin material.

11. The inkjet recording head of claim 1, wherein the top plate is a resin top plate which is formed of resin.

12. The inkjet recording head of claim 2, wherein the top plate is a resin top plate which is formed of resin.

13. The inkjet recording head of claim 3, wherein the top plate is a resin top plate which is formed of resin.

14. The inkjet recording head of claim 6, wherein the top plate is a resin top plate which is formed of resin.

15. The inkjet recording head of claim 11, wherein the resin top plate is molded integrally with a partitioning wall which structures the ink pooling chamber and supports the resin top plate.

16. The inkjet recording head of claim 12, wherein the resin top plate is molded integrally with a partitioning wall which structures the ink pooling chamber and supports the resin top plate.

17. The inkjet recording head of claim 13, wherein the resin top plate is molded integrally with a partitioning wall which structures the ink pooling chamber and supports the resin top plate.

18. The inkjet recording head of claim 14, wherein the resin top plate is molded integrally with a partitioning wall which structures the ink pooling chamber and supports the resin top plate.

19. The inkjet recording head of claim 11, wherein the first wire is formed by a three-dimensional wiring forming process.

20. The inkjet recording head of claim 15, wherein the first wire is formed by a three-dimensional wiring forming process.

21. The inkjet recording head of claim 11, wherein the air damper is molded integrally with the resin top plate.

22. The inkjet recording head of claim 15, wherein the air damper is molded integrally with the resin top plate.

23. The inkjet recording head of claim 19, wherein the air damper is molded integrally with the resin top plate.

24. The inkjet recording head of claim 11, wherein a gap, which is between the vibrating plate and the resin top plate and at which the driving IC is disposed, is filled-in with a resin material.

25. The inkjet recording head of claim 15, wherein a gap, which is between the vibrating plate and the resin top plate and at which the driving IC is disposed, is filled-in with a resin material.

26. The inkjet recording head of claim 19, wherein a gap, which is between the vibrating plate and the resin top plate and at which the driving IC is disposed, is filled-in with a resin material.

27. The inkjet recording head of claim 21, wherein a gap, which is between the vibrating plate and the resin top plate and at which the driving IC is disposed, is filled-in with a resin material.

28. An inkjet recording apparatus comprising the inkjet recording head of claim 1.

29. An inkjet recording head comprising:
a nozzle ejecting ink droplets;
a pressure chamber which communicates with the nozzle and in which ink is filled;
a vibrating plate structuring a portion of the pressure chamber;
an ink pooling chamber pooling ink to be supplied to the pressure chamber via an ink flow path;
a piezoelectric element displacing the vibrating plate; and
a driving IC provided on a same substrate as the piezoelectric element, and applying voltage to the piezoelectric element,
wherein a first wire for energizing the driving IC is formed at a top plate of the ink pooling chamber which is provided at a side of the vibrating plate opposite a side at which the pressure chamber is provided,
the ink pooling chamber is structured by a piezoelectric element substrate which is formed so as to include the vibrating plate and at which the piezoelectric element is provided, the top plate, and a partitioning wall supporting the top plate,
the first wire and the driving IC are connected at a bump which is disposed between the piezoelectric element substrate and the top plate,
the ink pooling chamber has an ink supplying opening supplying ink, and an air damper absorbing pressure waves of the ink pooled in the ink pooling chamber, and the air damper is provided at the top plate,
the top plate is a resin top plate, and the resin top plate is molded integrally with the air damper and with the partitioning wall which structures the ink pooling chamber and supports the resin top plate, and
a gap, which is between the vibrating plate and the resin top plate and at which the driving IC is disposed, is filled-in with a resin material.

30. An inkjet recording apparatus comprising the inkjet recording head of claim 29.
